(19) United States
(12) Patent Application Publication
(10) Pub. No.: US 2025/0384566 A1
(43) Pub. Date: Dec. 18, 2025

(54) INFORMATION PROCESSING DEVICE AND INFORMATION PROCESSING METHOD

(71) Applicant: Sony Group Corporation, Tokyo (JP)

(72) Inventor: Kei Oishi, Kanagawa (JP)

(73) Assignee: Sony Group Corporation, Tokyo (JP)

(21) Appl. No.: 18/878,781

(22) PCT Filed: Jun. 20, 2023
(86) PCT No.: PCT/JP2023/022701

§ 371 Date: Dec. 24, 2024

(30) Foreign Application Priority Data
Jul. 6, 2022 (JP) 2022-109278

(51) Int. Cl. G06T 7/254; G01S 17/89

(52) U.S. Cl. CPC G06T 7/254; G01S 17/89; G06T 2207/10028; G06T 2207/20224

(57) ABSTRACT

Detection of a moving body region, generation of a high-density point cloud, and the like can be achieved in a preferable manner.

A processing unit performs a process that forms a first depth image by projecting a LiDAR point cloud on a camera image plane, a process that forms a second depth image by using a camera image according to an optical flow, and a process that compares the first depth image and the second depth image to detect a moving body region or a non-moving body region. For example, the processing unit further performs a process that generates a high-density point cloud by projecting LiDAR point clouds corresponding to non-moving body regions of a plurality of frames on an identical coordinate system and sequentially merging the LiDAR point clouds.

### TECHNICAL FIELD

The present technology relates to an information processing device and an information processing method, and particularly to an information processing device and the like for performing processing based on camera images and LiDAR point clouds.

### BACKGROUND ART

Advanced driver-assistance systems and automated driving technologies have been actively developed in recent years. Among the technologies in this field, a technology for detecting a moving body is absolutely essential for avoiding accidents. Moreover, sensing of an entire circumference of a vehicle is often required so as to achieve safer and more advanced automated driving.

For detecting a moving body around a vehicle, technologies such as semantic segmentation and instance segmentation are usually employed. It is difficult, however, to recognize an object not falling within a labelling range of these technologies. Moreover, it is difficult to recognize, with use of a single camera, an object out of labelling and nonrigid, such as an object changing its shape like a flag, and a region corresponding to a moving body but not causing inconsistency with a trajectory of a camera, such as a region of a vehicle body moving completely in the same manner as the moving manner of the camera.

If higher-precision and higher-definition recognition of surroundings is enabled, small steps such as dropped trash and dumps on roads become distinguishable. In this case, comfortable driving is providable for users. Safe parking is achievable even on a complicated structure such as a multistory parking facility. A surround view system currently providing planar visualization is further allowed to provide stereoscopic visualization which enables a driver to intuitively recognize an obstacle during driving or parking.

In addition to driver-assistance systems, construction of safe remote driving systems is achievable by three-dimensional transfer of information associated with surroundings of a vehicle. Thus, high-precise and high-definition observation around a vehicle is a technology essential for future automated driving technologies.

Devices such as a plurality of cameras, LiDAR (Light Detection And Ranging), and Radar (Radio Detecting and Ranging) are currently employed for observing surroundings of a vehicle. However, for example, LiDAR and Radar are capable of performing high-precise observation but are not good at high-density observation. Meanwhile, a camera is capable of performing high-density observation but is not good at high-precise observation.

Accordingly, it has been promoted to develop a fusion technology using a plurality of devices, such as LiDAR or Radar together with cameras. Particularly, for achieving high-precise and high-density environmental recognition, development of a depth completion technology has been promoted in recent years, such as estimation of depths from video images of a camera, and up-sampling of LiDAR based on a guide of video images of a camera. In many situations, estimation of depths using deep learning is usually adopted. In this case, there may arise a problem associated with collection of datasets. Acquisition of high-precise and high-density depths requires huge amounts of labor.

For example, PTL 1 discloses a technology which analyzes clusters of LiDAR and monitors these clusters in a time-series manner to detect a moving body. In the case of this technology, it is easily estimated that cluster analysis requires a certain number of points. It is therefore assumed that this analysis is difficult to achieve in a case of sparse LiDAR or a small target. Moreover, a cluster method for this technology is not particularly specified, and a moving body is difficult to clearly detect depending on cluster division, or erroneous or no detection. Furthermore, a point cloud of a nonrigid object, such as a flag or the like which maintains its position but changes its shape, cannot be removed by using this technology.

In addition, for example, PTL 2 discloses a technology which records a trajectory of a moving body by using a stereo camera and maps a calibrated LiDAR point cloud on a 3D (three dimensions) environment to implement a highly precise 3D reconfiguration. This technology uses a RANSAC (Random Sample Consensus) algorithm at the time of trajectory prediction of the moving body to ignore influences of the moving body. However, at the time of mapping of the LiDAR point cloud on the 3D environment, the point cloud of the moving body recorded by LiDAR cannot be removed.

### CITATION LIST

### Patent Literature

### [PTL 1]

Japanese Patent Laid-open No. 2022-025269

### [PTL 2]

Japanese Translations of PCT for Patent No. 2016-516977

### SUMMARY

### Technical Problem

An object of the present technology is to enable preferable detection of a moving body region, enable preferable generation of high-density point clouds, enable preferable formation of high-density depth images, and others.

### Solution to Problem

A conception of the present technology is directed to an information processing device including a processing unit that performs
a process that forms a first depth image by projecting a LiDAR point cloud on a camera image plane,
a process that forms a second depth image by using a camera image according to an optical flow, and
a process that compares the first depth image and the second depth image to detect a moving body region or a non-moving body region.

According to the present technology, the processing unit performs a process that forms a first depth image by projecting a LiDAR point cloud on a camera image plane, a process that forms a second depth image by using a camera image according to an optical flow, and a process that compares the first depth image and the second depth image to detect a moving body region or a non-moving body region.

For example, when a relative error of a depth included in depths of the first depth image and located at an image position identical to an image position of a depth of the second depth image is larger than a threshold in the process that detects the moving body region, the processing unit may detect the image position of the corresponding depth of the first depth image as the moving body region. In this case, for example, the relative error may be a value obtained by dividing an absolute value of a difference between a depth of the first depth image and a depth of the second depth image by the depth of the first depth image.

Moreover, for example, when a relative error of a depth included in depths of the first depth image and located at an image position identical to an image position of a depth of the second depth image is smaller than or equal to a threshold in the process that detects the non-moving body region, the processing unit may detect the image position of the corresponding depth of the first depth image as the non-moving body region. In this case, for example, the relative error may be a value obtained by dividing an absolute value of a difference between a depth of the first depth image and a depth of the second depth image by the depth of the first depth image.

As described above, according to the present technology, the moving body region or the non-moving body region is detected on the basis of the comparison between the first depth image formed by projecting the LiDAR point cloud on the camera image plane and the second depth image formed using the camera image according to the optical flow. Accordingly, whether or not each region is the moving body region is recognizable without a necessity of labelling the moving body as a vehicle, a human, or the like, and therefore preferable detection of the moving body region or the non-moving body region is achievable.

In addition, according to the present technology, for example, the processing unit may further perform a process that projects the LiDAR point clouds corresponding to the non-moving body regions of a plurality of frames on an identical coordinate system, and sequentially merges the LiDAR point clouds to generate a high-density point cloud. In this manner, a preferable high-density three-dimensional environment (high-density point cloud) from which the moving body region has been removed can be constructed. Note that the three-dimensional environment in this case is constructed using the LiDAR point clouds. Accordingly, preferable construction of a high-density three-dimensional environment from which the moving body region has been removed is achievable even in an environment containing no pattern, such as a white wall.

For example, the processing unit may further perform a process that forms a third depth image by designating at least any one of the plurality of frames as a target frame and projecting the high-density point cloud from which the moving body region has been removed on a camera image plane of the target frame, a process that forms a fourth depth image by using a camera image of the target frame according to the optical flow, a process that compares the third depth image and the fourth depth image to detect an occlusion region, and a process that extracts a depth of a region corresponding to the camera image of the target frame and not corresponding to the occlusion region, from among depths of the third depth image to obtain a high-density depth image of the target frame. In this manner, a preferable high-density depth image from which the moving body region and the occlusion region have been removed can be obtained.

In addition, when a relative error of a depth included in the depths of the third depth image and located at an image position identical to an image position of a depth of the fourth depth image is larger than a threshold in the process that detects the occlusion region, the processing unit may detect the image position of the corresponding depth of the third depth image as the occlusion region. In this case, the relative error may be a value obtained by dividing an absolute value of a difference between a depth of the third depth image and a depth of the fourth depth image by the depth of the third depth image.

In this case, for example, by using the high-density depth images corresponding to a plurality of the frames and obtained by the process that obtains the high-density depth image of the target frame, the processing unit may further perform a process that generates datasets including sparse depth images obtained by projecting the high-density depth images, the camera images, and the LiDAR point clouds corresponding to the plurality of frames on the camera image plane, and stores the datasets in a database.

In addition, in this case, for example, the processing unit may further perform a process that generates an inference model for obtaining the high-density depth images from the camera images and the sparse depth images on the basis of the datasets corresponding to the plurality of frames and stored in the database.

Moreover, another conception of the present technology is directed to an information processing method including
a procedure that forms a first depth image by projecting a LiDAR point cloud on a camera image plane,
a procedure that forms a second depth image by using a camera image according to an optical flow, and
a procedure that compares the first depth image and the second depth image to detect a moving body region or a non-moving body region.

Furthermore, a further conception of the present technology is directed to an information processing device including a processing unit that performs
a process that generates a high-density point cloud by projecting LiDAR point clouds of a plurality of frames on an identical coordinate system and sequentially merging the LiDAR point clouds,
a process that forms a first depth image by designating at least any one of the plurality of frames as a target frame and projecting the high-density point cloud on a camera image plane of the target frame,
a process that forms a second depth image by using a camera image of the target frame according to an optical flow,
a process that compares the first depth image and the second depth image to detect regions of a moving body and an occlusion, and
a process that extracts a depth of a region corresponding to the camera image of the target frame and not corresponding to the regions of the moving body and the occlusion from depths of the first depth image to obtain a high-density depth image of the target frame.

According to the present technology, the processing unit performs a process that generates a high-density point cloud by projecting LiDAR point clouds of a plurality of frames on an identical coordinate system and sequentially merging the LiDAR point clouds, a process that forms a first depth image by designating at least any one of the plurality of frames as a target frame and projecting the high-density point cloud on a camera image plane of the target frame, and a process that forms a second depth image by using a camera image of the target frame according to an optical flow. The processing unit further performs a process that compares the first depth image and the second depth image to detect regions of a moving body and an occlusion, and a process that extracts a depth of a region corresponding to the camera image of the target frame and not corresponding to the regions of the moving body and the occlusion from depths of the first depth image to obtain a high-density depth image of the target frame.

For example, when a relative error of a depth included in depths of the first depth image and located at an image position identical to an image position of a depth of the second depth image is larger than a threshold in the process that detects the regions of the moving body and the occlusion, the processing unit may detect the image position of the corresponding depth of the first depth image as the regions of the moving body and the occlusion. In this case, for example, the relative error may be a value obtained by dividing an absolute value of a difference between a depth of the first depth image and a depth of the second depth image by the depth of the first depth image.

As described above, according to the present technology, the high-density point cloud is generated by projecting the LiDAR point clouds of the plurality of frames on the identical coordinate system and sequentially merging the LiDAR point clouds. The regions of the moving body and the occlusion are detected on the basis of the comparison between the first depth image formed by designating at least any one of the plurality of frames as a target frame and projecting the high-density point cloud on the camera image plane of the target frame, and the second depth image formed by using the camera image of the target frame according to the optical flow. The depth of the region corresponding to the camera image of the target frame and not corresponding to the regions of the moving body and the occlusion is extracted to obtain the high-density depth image of the target frame. Accordingly, a preferable high-density depth image from which the moving body region and the occlusion region have been removed can be formed.

In this case, for example, by using the high-density depth images corresponding to a plurality of the frames and obtained by the process that obtains the high-density depth image of the target frame, the processing unit may further perform a process that generates datasets including sparse depth images obtained by projecting the high-density depth images, the camera images, and the LiDAR point clouds corresponding to the plurality of frames on the camera image plane, and stores the datasets in a database.

In addition, in this case, for example, the processing unit may further perform a process that generates an inference model for obtaining the high-density depth images from the camera images and the sparse depth images on the basis of the datasets corresponding to the plurality of frames and stored in the database.

Furthermore, a still further conception of the present technology is directed to an information processing method including
a procedure that generates a high-density point cloud by projecting LiDAR point clouds of a plurality of frames on an identical coordinate system and sequentially merging the LiDAR point clouds,
a procedure that forms a first depth image by designating at least any one of the plurality of frames as a target frame and projecting the high-density point cloud on a camera image plane of the target frame,
a procedure that forms a second depth image by using a camera image of the target frame according to an optical flow,
a procedure that compares the first depth image and the second depth image to detect regions of a moving body and an occlusion, and
a procedure that extracts a depth of a region corresponding to the camera image of the target frame and not corresponding to the regions of the moving body and the occlusion from depths of the first depth image to obtain a high-density depth image of the target frame.

### BRIEF DESCRIPTION OF DRAWINGS

FIG. 1 is a block diagram illustrating a configuration example of a moving body detecting system according to a first embodiment.

FIG. 2 is a flowchart illustrating an example of processing procedures for detecting a moving body performed by a moving body detection device for each frame.

FIG. 3 is a block diagram illustrating a configuration example of a high-density depth image forming system according to a third embodiment.

FIG. 4 is a block diagram illustrating a configuration example of a non-moving body detection unit.

FIG. 5 is a diagram schematically illustrating a frame relation between generation of a high-density point cloud and formation of a high-density depth image of a target frame in a case of use of a first method which generates a high-density point cloud by using data of all frames acquired from a sensor.

FIG. 6 is a diagram schematically illustrating an example of a frame relation between generation of a high-density point cloud and formation of a high-density depth image of a target frame in a case of use of a second method which generates a high-density point cloud by sequentially using data of a predetermined number of frames acquired from the sensor.

FIG. 7 is a diagram schematically illustrating a different example of the frame relation between generation of a high-density point cloud and formation of a high-density depth image of a target frame in the case of use of the second method which generates a high-density point cloud by sequentially using data of a predetermined number of frames acquired from the sensor.

FIG. 8 is a diagram schematically illustrating a different example of the frame relation between generation of a high-density point cloud and formation of a high-density depth image of a target frame in the case of use of the second method which generates a high-density point cloud by sequentially using data of a predetermined number of frames acquired from the sensor.

FIG. 9 is a flowchart illustrating an example of processing procedures performed by the high-density depth image forming system for forming a high-density depth image in the case of use of the first method.

FIG. 10 is a flowchart illustrating an example of processing procedures performed by the high-density depth image forming system for forming a high-density depth image in the case of use of the second method.

FIG. 11 is a block diagram illustrating a configuration example of a high-density depth image forming system according to a third embodiment.

FIG. 12 is a flowchart illustrating an example of processing procedures performed by the high-density depth image forming system for forming a high-density depth image in the case of use of the first method.

FIG. 13 is a flowchart illustrating an example of processing procedures performed by the high-density depth image forming system for forming a high-density depth image in the case of use of the second method.

FIG. 14 is a block diagram illustrating a configuration example of a data collecting system according to a fourth embodiment.

FIG. 15 is a flowchart illustrating an example of processing procedures performed by the data collecting system for collecting data.

FIG. 16 is a block diagram illustrating a configuration example of a learning system according to a fifth embodiment.

FIG. 17 is a flowchart illustrating an example of processing procedures performed by the learning system for learning.

FIG. 18 is a block diagram illustrating a configuration example of a high-density depth image inference system according to a sixth embodiment.

FIG. 19 is a flowchart illustrating an example of processing procedures performed by the high-density depth image inference system for achieving high-density depth image inference for each frame.

FIG. 20 is a block diagram illustrating a hardware configuration example of a computer.

### DESCRIPTION OF EMBODIMENTS

Modes for carrying out the invention (hereinafter referred to as embodiments) will be described hereinbelow. Note that the description will be presented in the following order.
1. First Embodiment
2. Second Embodiment
3. Third Embodiment
4. Fourth Embodiment
5. Fifth Embodiment
6. Sixth Embodiment
7. Modifications

### 1. First Embodiment

### [Moving Body Detecting System]

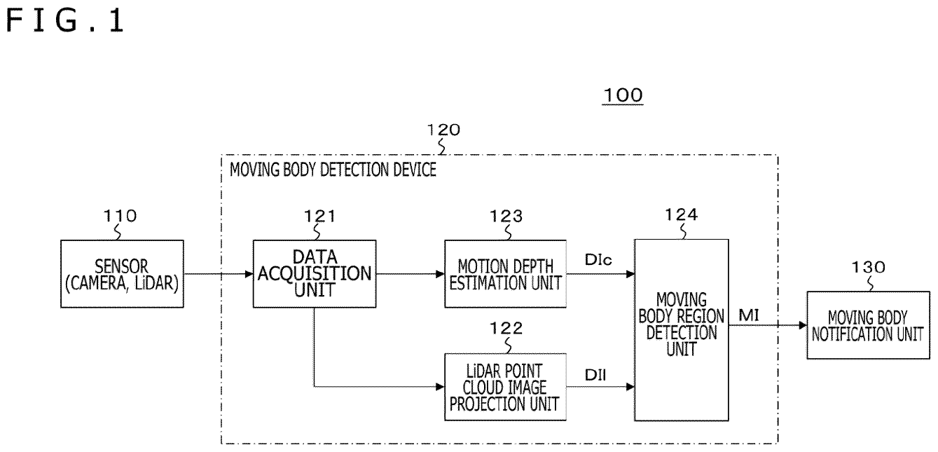

FIG. 1 illustrates a configuration example of a moving body detecting system 100 according to the first embodiment. For example, the moving body detecting system 100 in this example is mounted and used on an independent moving body such as a vehicle and a robot.

The moving body detecting system 100 includes a sensor 110, a moving body detection device 120, and a moving body notification device 130. The sensor 110 includes at least a camera and a LiDAR (Light Detection And Ranging) sensor.

The moving body detection device 120 detects a moving body region included in a camera image region for each frame on the basis of a camera image and a LiDAR point cloud acquired from the sensor 110. The moving body detection device 120 includes a data acquisition unit 121, a LiDAR point cloud image projection unit 122, a motion depth estimation unit 123, and a moving body region detection unit 124.

The data acquisition unit 121 acquires data obtained by the sensor 110, or a camera image and a LiDAR point cloud in this embodiment, for each frame.

The LiDAR point cloud image projection unit 122 forms a depth image DIl in a camera coordinate system for each frame on the basis of the LiDAR point cloud acquired by the data acquisition unit 121.

It is assumed herein that a principal point and a focal distance of the camera have been estimated beforehand as an internal parameter matrix K expressed as formula (1) presented below. In formula (1), (cx, cy) indicates the principal point (usually corresponding to the center of the image), while each of fx and fy indicates the focal distance expressed by a pixel unit.

$$\begin{matrix}[ Math . 1 ] & \\ K = [ \begin{matrix}{f}_{x} & 0 & {c}_{x} \\ 0 & {f}_{u} & {c}_{y} \\ 0 & 0 & 1\end{matrix} ] & ( 1 )\end{matrix}$$

It is further assumed that positions and postures of the camera and the LiDAR sensor have been estimated beforehand as a rotation matrix R expressed as formula (2) presented below, and a translation matrix t expressed as formula (3) presented below.

$$\begin{matrix}[ Math . 2 ] & \\ R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] & ( 2 )\end{matrix}$$

$$t = [ \begin{matrix}{t}_{1} \\ {t}_{2} \\ {t}_{3}\end{matrix} ] \qquad ( 3 )$$

In this case, as presented in the following formula (4), the system of the LiDAR point cloud is initially converted into a camera image system by using the rotation matrix R and the translation matrix t. In formula (4) herein, (Xl, Yl, Zl) indicates coordinates in the LiDAR coordinate system within a three-dimensional space, while (Xc, Yc, Zc) indicates coordinates in the camera coordinate system within the three-dimensional space.

$$\begin{matrix}[ Math . 3 ] & \\ [ \begin{matrix}{X}_{c} \\ {Y}_{c} \\ {Z}_{c}\end{matrix} ] = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}{X}_{l} \\ {Y}_{l} \\ {Z}_{l}\end{matrix} ] & ( 4 )\end{matrix}$$

Subsequently, as presented in the following equation (5), coordinates (u, v) in an image plane are obtained using the internal parameter matrix, and also a depth dl is obtained using the following equation (6). Note that a symbol “˜” in formula (5) represents equivalence as homogeneous coordinates.

$$\begin{matrix}[ Math . 4 ] & \\ [ \begin{matrix}u \\ v \\ 1\end{matrix} ] \sim [ \begin{matrix}{f}_{x} & 0 & {c}_{x} \\ 0 & {f}_{u} & {c}_{y} \\ 0 & 0 & 1\end{matrix} ] [ \begin{matrix}{X}_{c} \\ {Y}_{c} \\ {Z}_{c}\end{matrix} ] & ( 5 )\end{matrix}$$

$${d}_{l} = {Z}_{c} \qquad ( 6 )$$

The motion depth estimation unit 123 forms a depth image DIc by using a camera image according to an optical flow. For forming the depth image according to the optical flow, depths are estimated by triangulation. It is assumed herein that poses from a time t to a time t+x have been already estimated by using a device such as a GPS, an IMU, a camera, and LiDAR, and that a perspective projection matrix P of these poses has been obtained.

A relation of the following formula (7) holds between coordinates of an image (perspective projection coordinates) and coordinates of a three-dimensional point cloud (three-dimensional coordinates). Note that formula (7) is expressed by using formula (8). In formula (8) presented below, (x, y) indicates the coordinates of the image, while (X, Y, Z) indicates the coordinates of the three-dimensional point cloud. In addition, A in formula (8) is an unknown scalar.

$$\begin{matrix}[ Math . 5 ] & \\ λ x = PX & ( 7 )\end{matrix}$$

$$λ [ \begin{matrix}x \\ y \\ 1\end{matrix} ] = [ \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34}\end{matrix} ] [ \begin{matrix}X \\ Y \\ Z \\ 1\end{matrix} ] \qquad ( 8 )$$

Formula (8) is transformed into the following formula (9) and formula (10).

$$\begin{matrix}[ Math . 6 ] & \\ ( {p}_{11} - {p}_{31} x ) X + ( {p}_{12} - {p}_{32} x ) Y + ( {p}_{13} - {p}_{33} x ) Z = {p}_{34} x - {p}_{14} & ( 9 )\end{matrix}$$

$$( {p}_{21} - {p}_{31} x ) X + ( {p}_{22} - {p}_{32} x ) Y + ( {p}_{23} - {p}_{33} x ) Z = {p}_{34} x - {p}_{24} \qquad ( 10 )$$

Note herein that the three unknown numerals X, Y, and Z are present. Accordingly, it is obvious that at least two images are only required. The coordinates of the three-dimensional point cloud (three-dimensional coordinates) can be obtained by considering the relation between the coordinates of the image in the current frame (perspective projection coordinates) and the coordinates of the three-dimensional point cloud (three-dimensional coordinates), i.e., λx=P₀X and the relation between the coordinates of the image in the reference frame (perspective projection coordinates) and the coordinates of the three-dimensional point cloud (three-dimensional coordinates), i.e., λ(x+f)=PX. In this case, P₀ is a unit matrix, while f is an optical flow.

A depth dc is calculated from the coordinates of the three-dimensional point cloud (three-dimensional coordinates) obtained as described above in a manner similar to the manner for obtaining the LiDAR described above (see formula (6) described above). Note that the depth dc can be estimated by using at least two images as described above. However, the depth dc may be estimated on the basis of a larger number of images.

The moving body region detection unit 124 compares the depth image DIL formed by the LiDAR point cloud image projection unit 122 with the depth image DIc formed by the motion depth estimation unit 123 for each frame to detect a moving body region. In this case, the depth dc of the depth image DIc obtained according to the optical flow has a value different from an actual depth in a moving body region.

Accordingly, in a case where the following formula (11) holds concerning the depth dl which is included in the respective depths dl of the depth image DIl each sequentially designated as a processing target and is located at the same image position (coordinates) as the position of any one of the depths dc of the depth image DIc, i.e., when a relative error |dl−dc|/dl is larger than a threshold ε, the moving body region detection unit 124 detects the image position of this depth dl as the moving body region. Note herein that the relative error is a value obtained by dividing an absolute value of a difference between the depth dl and the depth dc by the depth dl.

$$\vert d \vert - d c \vert / d \vert > ε \qquad ( 11 )$$

Moreover, the moving body region detection unit 124 transmits information MI associated with the detected moving body region to the moving body notification device 130 for each frame. Note herein that the information MI contains information associated with respective image positions (coordinates) of the detected moving body region, and information associated with the depths at the respective image positions (coordinates).

The moving body notification device 130 performs warning output and movement control concerning the independent moving body on the basis of the information MI associated with the moving body region and transmitted from the moving body region detection unit 124 of the moving body detection device 120 for each frame. For example, in a case where the moving body region is present at a short distance from the independent moving body in its traveling direction, the moving body notification device 130 outputs a warning, and also performs such control as reduction in traveling speed by a braking operation or change in traveling direction.

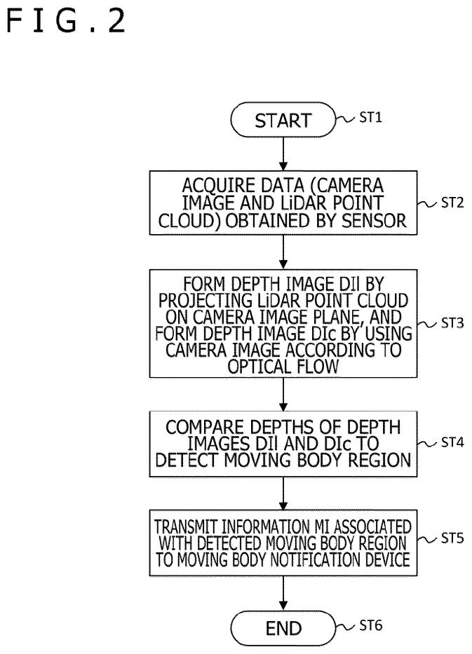

A flowchart in FIG. 2 illustrates an example of processing procedures performed by the moving body detection device 120 for detecting a moving body for each frame.

In step ST1, the moving body detection device 120 starts processing. In subsequent step ST2, the moving body detection device 120 causes the data acquisition unit 121 to acquire data (a camera image and a LiDAR point cloud) obtained by the sensor 110.

In subsequent step ST3, the moving body detection device 120 causes the LiDAR point cloud image projection unit 122 to form the depth image DIL by projecting the LiDAR point cloud on the camera image plane, and also causes the motion depth estimation unit 123 to form the depth image DIc by using the camera image according to the optical flow.

In subsequent step ST4, the moving body detection device 120 causes the moving body region detection unit 124 to compare the depth image DIl with the depth image DIc to detect a moving body region. When the relative error |dl−dc|/dl is larger than the threshold & in this step concerning the depth dl which is included in the respective depths dl of the depth image DIL each sequentially designated as a processing target and is located at the same image position (coordinates) as the image position of any one of the depths dc of the depth image DIc, the moving body region detection unit 124 detects the image position of this depth dl as a moving body region.

In subsequent step ST5, the moving body detection device 120 causes the moving body region detection unit 124 to transmit, to the moving body detection device 130, the information MI associated with the detected moving body region, i.e., information associated with the respective image positions (coordinates) of the detected moving body region, and information associated with the depths at the respective image positions (coordinates). In subsequent step ST6 after completion of the process in step ST5, the moving body detection device 120 ends processing.

As described above, the moving body detecting system 100 illustrated in FIG. 1 detects the moving body region on the basis of the comparison between the depth image DIl formed by projecting the LiDAR point cloud on the camera image plane, and the depth image DIc formed using the camera image according to the optical flow. Accordingly, whether or not each region is a moving body region is recognizable without a necessity of labelling the moving body as a vehicle, a human, or the like, and therefore preferable detection of moving body regions is achievable.

### 2. Second Embodiment

### [High-Density Depth Image Forming System]

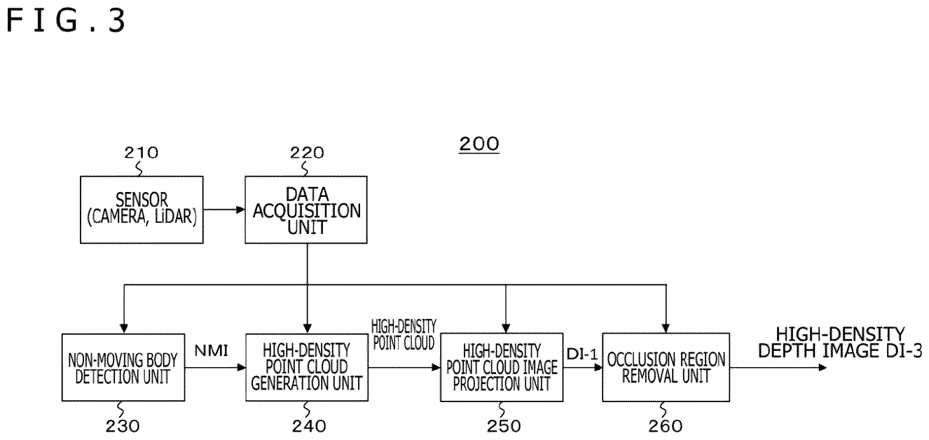

FIG. 3 illustrates a configuration example of a high-density depth image forming system 200 according to the second embodiment. For example, the high-density depth image forming system 200 in this example is mounted and used on an independent moving body such as a vehicle and a robot.

The high-density depth image forming system 200 includes a sensor 210, a data acquisition unit 220, a non-moving body detection unit 230, a high-density point cloud generation unit 240, a high-density point cloud image projection unit 250, and an occlusion region removal unit 260.

The sensor 210 includes at least a camera and a LiDAR (Light Detection And Ranging) sensor. The data acquisition unit 221 acquires and retains data obtained by the sensor 210 for each frame, or a camera image and a LiDAR point cloud in this embodiment.

The non-moving body detection unit 230 detects a non-moving body region (still region) within a camera image region for each frame by using camera images and LiDAR point clouds in respective frames acquired by the data acquisition unit 220.

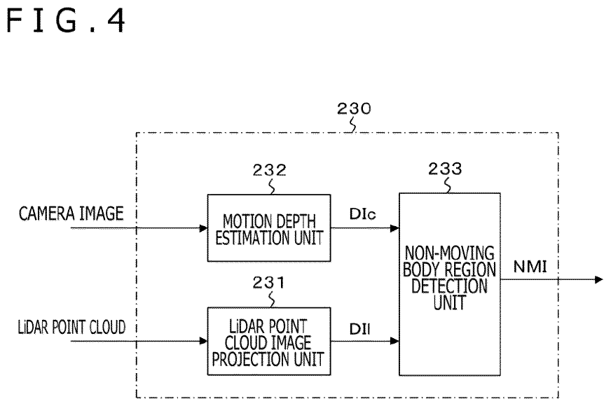

FIG. 4 illustrates a configuration example of the non-moving body detection unit 230. The non-moving body detection unit 230 includes a LiDAR point cloud image projection unit 231, a motion depth estimation unit 232, and a non-moving body region detection unit 233.

While not described in detail herein, the LiDAR point cloud image projection unit 231 projects a LiDAR point cloud on a camera image plane in a manner similar to the manner of the LiDAR point cloud image projection unit 122 included in the moving body detection device 120 of the moving body detecting system 100 described above and illustrated in FIG. 1 to form the depth image DIl in the camera coordinate system. Moreover, while not described in detail herein, the motion depth estimation unit 232 forms the depth image DIc by using a camera image according to the optical flow in a manner similar to the manner of the motion depth estimation unit 123 included in the moving body detection device 120 of the moving body detecting system 100 illustrated in FIG. 1.

The non-moving body region detection unit 233 compares the depth image DIL formed by the LiDAR point cloud image projection unit 231 with the depth image DIc formed by the motion depth estimation unit 232 to detect a non-moving body region (still region), and outputs information NMI associated with the non-moving body region. Note herein that the information NMI contains information associated with respective image positions (coordinates) of the detected non-moving body region, for example.

In this case, the depth dc of the depth image DIc obtained according to the optical flow has a value different from an actual depth in the moving body region. Accordingly, in a case where formula (11) described above does not hold concerning the depth dl included in the respective depths dl of the depth image DIL sequentially designated as a processing target and located at the same image position (coordinates) as the image position of any one of the depths dc of the depth image DIc, i.e., when a relative error |dl−dc|/dl is smaller than or equal to the threshold ε, the non-moving body region detection unit 233 detects the image position of this depth dl as the non-moving body region.

As described above, the non-moving body region detection unit 233 detects the non-moving body region on the basis of the comparison between the depth image DIl formed by projecting the LiDAR point cloud on the camera image plane and the depth image DIc formed using the camera image according to the optical flow. Accordingly, whether or not each current region is a moving body region is recognizable without a necessity of labelling the moving body as a vehicle, a human, or the like, and therefore preferable detection of non-moving body regions is achievable.

Returning to FIG. 3, the high-density point cloud generation unit 240 projects LiDAR point clouds corresponding to the non-moving body regions on the same coordinate system, such as a world coordinate system defined on the basis of a certain point, from a trajectory of the independent moving body in a manner similar to the manner of PTL 2 described above on the basis of the information NMI associated with the non-moving body regions and output from the non-moving body detection unit 230 for a plurality of frames, and sequentially merges the projected LiDAR point clouds to generate a high-density point cloud. Note herein that the trajectory of the independent moving body may be a trajectory acquired by a GPS (Global Positioning System) and an IMU (Inertial Measurement Unit), or a trajectory estimated by a camera or a LiDAR sensor.

In this manner, the high-density point cloud generation unit 240 can generate a high-density point cloud from which a moving body region has been removed, and therefore can construct a preferable high-density three-dimensional environment from which a moving body region has been removed. In this case, the three-dimensional environment is constructed using LiDAR point clouds. Accordingly, preferable construction of a high-density three-dimensional environment from which a moving body region has been removed is achievable even in an environment containing no pattern, such as a white wall.

The high-density point cloud image projection unit 250 designates at least any one of a plurality of frames formed by the high-density point cloud generation unit 240 described above as a target frame, and projects a high-density point cloud on a camera image plane of this target frame to form a depth image DI-1 of the target frame. The depth image DI-1 formed herein contains a depth error caused by occlusion.

The occlusion region removal unit 260 removes an occlusion region from the depth image DI-1 of the target frame formed by the high-density point cloud image projection unit 250 to obtain a high-density depth image DI-3 of the target frame from which the occlusion region has been removed.

In this case, the occlusion region removal unit 260 initially performs processing similar to the processing carried out by the moving body detection device 120 of the moving body detecting system 100 described above and illustrated in FIG. 1 to detect the occlusion region. Specifically, the occlusion region removal unit 260 forms a depth image DI-2 by using a camera image of the target frame according to the optical flow, and compares the depth image DI-2 with the depth image DI-1 of the target frame formed by the high-density point cloud image projection unit 250 to detect the occlusion region.

In this case, the occlusion region removal unit 260 sequentially designates respective depths d1 of the depth images DI-1 of the target frame formed by the high-density point cloud image projection unit 250 as a processing target. When a relative error of the depth d1 located at the same image position (coordinates) as the image position of any one of the depths d2 of the depth image DI-2 formed using the camera image of the target frame according to the optical flow is larger than a threshold, the occlusion region removal unit 260 detects the image position of this depth d1 as the occlusion region. Note herein that the relative error is a value obtained by dividing an absolute value of a difference between the depth d1 and the depth d2 by the depth d1, for example.

Thereafter, the occlusion region removal unit 260 subsequently extracts the depth d1 of the region corresponding to the camera image of the target frame and not corresponding to the occlusion region, from among the depths d1 of the depth image DI-1 of the target frame formed by the high-density point cloud image projection unit 250 to obtain the high-density depth image DI-3 of the target frame from which the occlusion region has been removed. Note herein that the depth d1 of the depth image DI-1 corresponding to the camera image of the target frame refers to the depth d1 located at the same image position (coordinates) as the image position of any one of the depths d2 of the depth image DI-2, and therefore refers to the depth d1 contained in the camera image region.

As described above, the high-density point cloud generation unit 240 generates a high-density point cloud by using LiDAR point clouds in a plurality of frames. This high-density point cloud may be generated using (1) a first method which uses data of all frames acquired by the data acquisition unit 220 from the sensor 210 or (2) a second method which sequentially uses data of a predetermined number of frames acquired by the data acquisition unit 220 from the sensor 210.

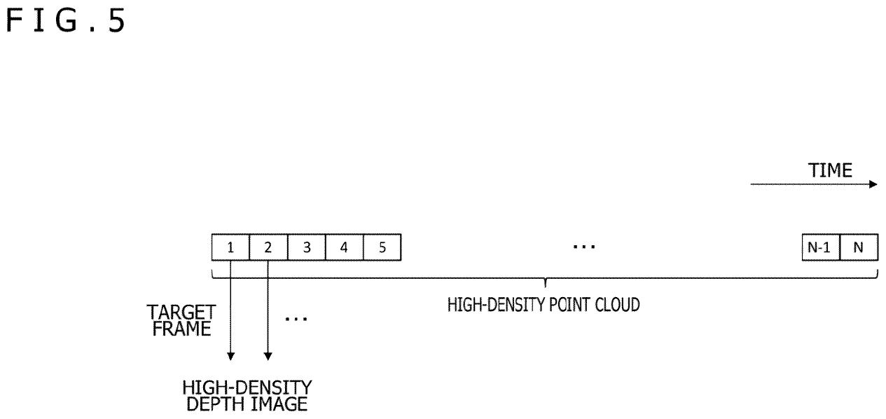

FIG. 5 schematically illustrates a frame relation between generation of a high-density point cloud and formation of a high-density depth image of a target frame in the case of use of the first method. In this case, a high-density point cloud is generated by using LiDAR point clouds in all frames, i.e., from a first frame to an Nth frame. Thereafter, a high-density depth image of a target frame is formed by using the generated high-density point cloud as a common point cloud while sequentially designating the frames as the target frame in an ascending order from the first frame.

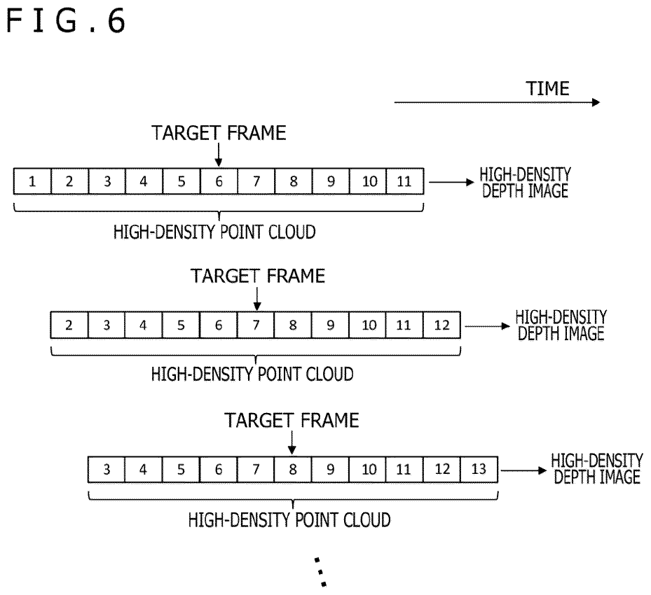

FIG. 6 schematically illustrates an example of a frame relation between generation of a high-density point cloud and formation of a high-density depth image in the case of use of the second method. In this case, a high-density point cloud is generated by using a target frame and a predetermined number of frames before and after the target frame, or five frames before and after the target frame in this example.

In this case, the sixth frame is initially designated as the target frame, and a high-density point cloud is generated using LiDAR point clouds of the first to eleventh frames. A high-density depth image of the sixth frame is formed using the high-density point cloud thus generated. Subsequently, the seventh frame is designated as the target frame, and a high-density point cloud is generated using LiDAR point clouds of the second to twelfth frames. A high-density depth image of the seventh frame is formed using the high-density point cloud thus generated. A high-density depth image is formed for each of the following target frames in a similar manner while sequentially shifting designation of the target frame.

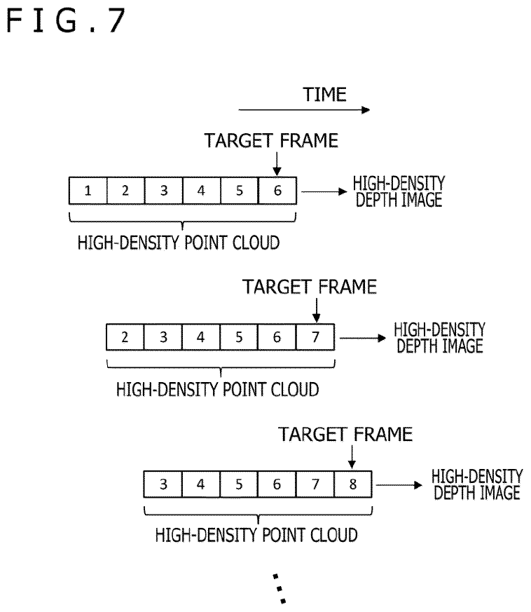

FIG. 7 schematically illustrates a different example of the frame relation between generation of a high-density point cloud and formation of a high-density depth image of a target frame in the case of use of the second method. This example illustrates a case for generating a high-density point cloud by using a target frame and a predetermined number of frames before the target frame, or five frames before the target frame in this example.

In this case, the sixth frame is initially designated as the target frame, and a high-density point cloud is generated using LiDAR point clouds of the first to sixth frames. A high-density depth image of the sixth frame is formed using the high-density point cloud thus generated. Subsequently, the seventh frame is designated as the target frame, and a high-density point cloud is generated using LiDAR point clouds of the second to seventh frames. A high-density depth image of the seventh frame is formed using the high-density point cloud thus generated. A high-density depth image is formed for each of the following target frames in a similar manner while sequentially shifting designation of the target frame.

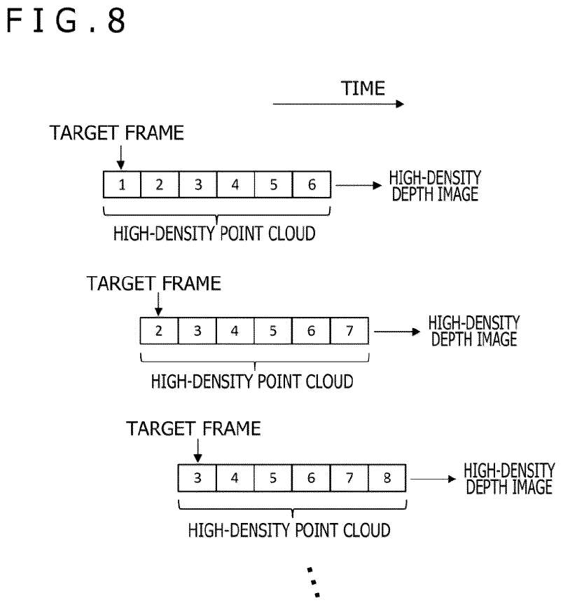

FIG. 8 schematically illustrates a further different example of the frame relation between generation of a high-density point cloud and formation of a high-density depth image of a target frame in the case of use of the second method. This example illustrates a case for generating a high-density point cloud by using a target frame and a predetermined number of frames after the target frame, or five frames after the target frame in this example.

In this case, the first frame is initially designated as the target frame, and a high-density point cloud is generated using LiDAR point clouds of the first to sixth frames. A high-density depth image of the first frame is formed using the high-density point cloud thus generated. Subsequently, the second frame is designated as the target frame, and a high-density point cloud is generated using LiDAR point clouds of the second to seventh frames. A high-density depth image of the second frame is formed using the high-density point cloud thus generated. A high-density depth image is formed for each of the following target frames in a similar manner while sequentially shifting designation of the target frame.

According to the case of use of the first method, the high-density depth image of the target frame cannot be formed before acquisition of data of all the frames by the data acquisition unit 220 from the sensor 210. However, according to the case of use of the second method, the high-density depth image can be sequentially formed for the respective target frames after acquisition of a predetermined number of data by the data acquisition unit 200 from the sensor 210.

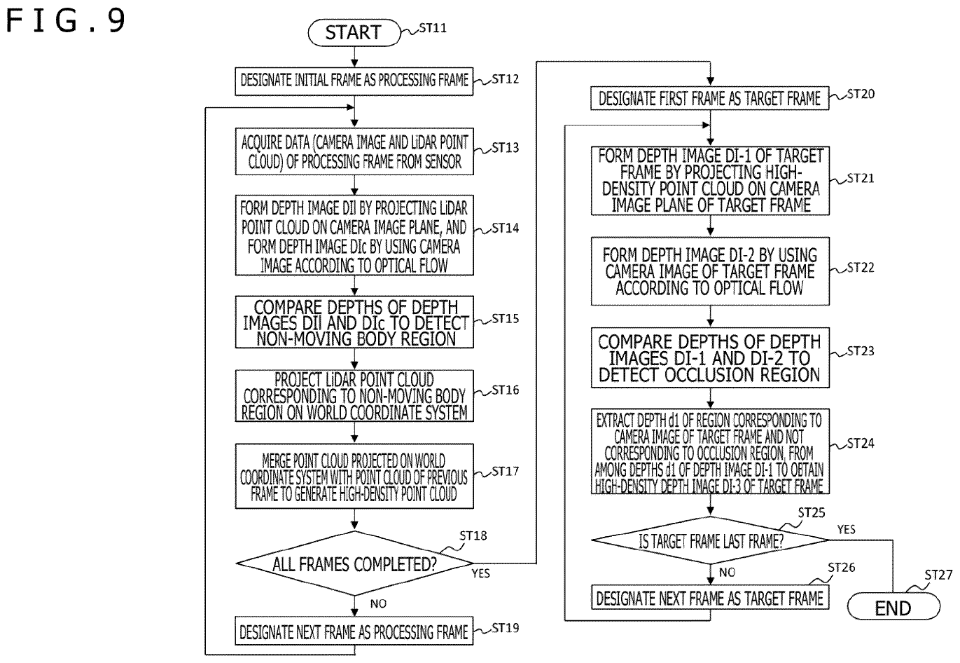

A flowchart in FIG. 9 illustrates an example of processing procedures performed by the high-density depth image forming system 200 for forming a high-density depth image. This example is a use case of the first method which generates a high-density point cloud by using data of all frames acquired by the data acquisition unit 220 from the sensor 210 (see FIG. 5).

In step ST11, the high-density depth image forming system 200 starts processing. In subsequent step ST12, the high-density depth image forming system 200 designates an initial frame as a processing frame.

In subsequent step ST13, the high-density depth image forming system 200 causes the data acquisition unit 220 to acquire data (a camera image and a LiDAR point cloud) of the processing frame from the sensor 210. In subsequent step ST14, the high-density depth image forming system 200 causes the non-moving body detection unit 230 to form the depth image DIL by projecting the LiDAR point cloud on the camera image plane, and form the depth image DIc by using the camera image according to the optical flow.

In subsequent step ST15, the high-density depth image forming system 200 causes the non-moving body detection unit 230 to compare the depth image DIL and the depth image DIc to detect a non-moving body region. When the relative error |dl−dc|/dl is smaller than or equal to the threshold & in this step concerning the depth dl which is included in the respective depths dl of the depth images DIl each sequentially designated as a processing target and is located at the same image position (coordinates) as the image position of any one of the depths dc of the depth image DIc, the non-moving body detection unit 230 detects the image position of this depth dl as the non-moving body region.

In subsequent step ST16, the high-density depth image forming system 200 causes the high-density point cloud generation unit 240 to project the LiDAR point cloud corresponding to the non-moving body region on the world coordinate system. In subsequent step ST17, the high-density depth image forming system 200 causes the high-density point cloud generation unit 240 to merge the point cloud projected on the world coordinate system with a point cloud of a previous frame to form a high-density point cloud.

In subsequent step ST18, the high-density depth image forming system 200 determines whether processing has been completed for all the frames. When processing is not completed for all the frames, the high-density depth image forming system 200 shifts the processing frame to a next frame in step ST19. After completion of this processing in step ST19, the high-density depth image forming system 200 returns the flow to step ST13 to repeat processing similar to the processing described above.

When processing for all the frames is completed in step ST18, i.e., when a high-density point cloud is generated using data of all the frames acquired by the data acquisition unit 220 from the sensor 210, the high-density depth image forming system 200 designates the first frame as the target frame in step ST20.

In subsequent step ST21, the high-density depth image forming system 200 causes the high-density point cloud image projection unit 250 to project the high-density point cloud on the camera image plane of the target frame to form the depth image DI-1 of the target frame. In subsequent step ST22, the high-density depth image forming system 200 causes the occlusion region removal unit 260 to form the depth image DI-2 by using the camera image of the target frame according to the optical flow.

In subsequent step ST23, the high-density depth image forming system 200 causes the occlusion region removal unit 260 to compare the depth image DI-1 and the depth image DI-2 to detect an occlusion region. When the relative error |d1−d2|/d1 is larger than a threshold in this step concerning the depth d1 which is included in the respective depths d1 of the depth image DI-1 each sequentially designated as the processing target and is located at the same image position (coordinates) as the image position of any one of the depths d2 of the depth image DI-2, the occlusion region removal unit 260 detects the image position of this depth d1 as the occlusion region.

In subsequent step ST24, the high-density depth image forming system 200 causes the occlusion region removal unit 260 to extract the depth d1 of the region corresponding to the camera image of the target frame and not corresponding to the occlusion region, from among the depths d1 of the depth image DI-1 to obtain the high-density depth image DI-3 of the target frame from which the occlusion region has been removed.

In subsequent step ST25, the high-density depth image forming system 200 determines whether the target frame is the last frame. Note that the last frame may be the Nth frame associated with generation of the high-density point cloud illustrated in FIG. 5, or may be a frame before the Nth frame.

When the target frame is not the last frame, the high-density depth image forming system 200 designates the next frame as the target frame in step ST26, and then returns the flow to the processing in step ST21 to repeat processing similar to the processing described above and obtain the high-density depth image DI-3 of the target frame from which the occlusion region has been removed. When the target frame is the last frame in step ST25, the high-density depth image forming system 200 ends processing in step ST27.

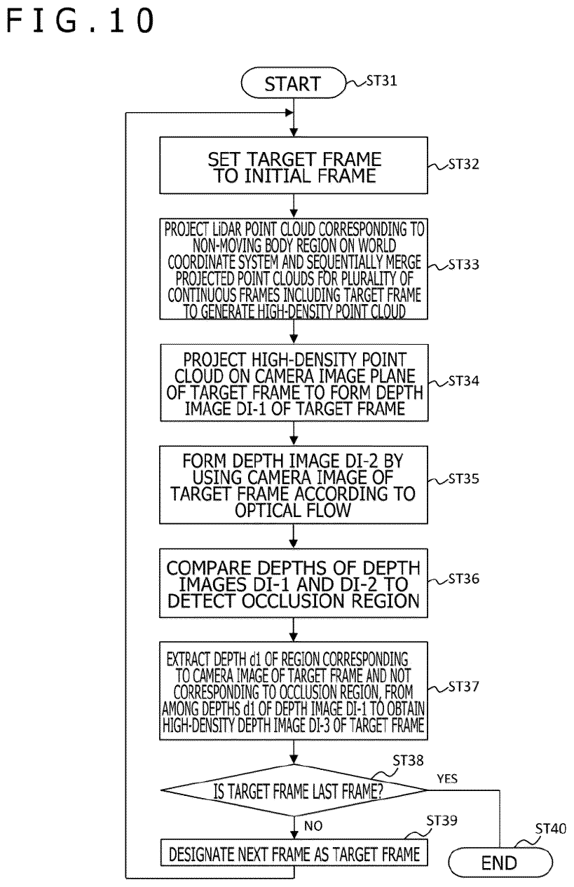

A flowchart in FIG. 10 illustrates a different example of processing procedures performed by the high-density depth image forming system 200 for forming a high-density depth image. This example is a use case of the second method which generates a high-density point cloud by sequentially using data of a predetermined number of frames acquired by the data acquisition unit 220 from the sensor 210 (see FIGS. 6, 7, and 8).

In step ST31, the high-density depth image forming system 200 starts processing. In subsequent step ST32, the high-density depth image forming system 200 sets an initial frame as a target frame. For example, the initial frame in the case illustrated in FIG. 6 is the sixth frame, the initial frame in the case illustrated in FIG. 7 is the sixth frame, and the initial frame in the case illustrated in FIG. 8 is the first frame.

In subsequent step ST33, the high-density depth image forming system 200 causes the non-moving body detection unit 230 and the high-density point cloud generation unit 240 to project LiDAR point clouds each corresponding to a non-moving body region on the world coordinate system for a plurality of continuous frames including the target frame, and sequentially merge the projected LiDAR point clouds to generate a high-density point cloud.

In subsequent step ST34, the high-density depth image forming system 200 causes the high-density point cloud image projection unit 250 to project the high-density point cloud on the camera image plane of the target frame to form the depth image DI-1 of the target frame. In subsequent step ST35, the high-density depth image forming system 200 causes the occlusion region removal unit 260 to form the depth image DI-2 by using the camera image of the target frame according to the optical flow.

In subsequent step ST36, the high-density depth image forming system 200 causes the occlusion region removal unit 260 to compare the depth image DI-1 and the depth image DI-2 to detect an occlusion region. When the relative error |d1−d2|/d1 is larger than a threshold in this step concerning the depth d1 which is included in the respective depths d1 of the depth image DI-1 each sequentially designated as the processing target and is located at the same image position (coordinates) as the image position of any one of the depths d2 of the depth image DI-2, the occlusion region removal unit 260 detects the image position of this depth d1 as the occlusion region.

In subsequent step ST37, the high-density depth image forming system 200 causes the occlusion region removal unit 260 to extract the depth d1 of the region corresponding to the camera image of the target frame and not corresponding to the occlusion region, from among the depths d1 of the depth image DI-1 to obtain the high-density depth image DI-3 of the target frame from which the occlusion region has been removed.

In subsequent step ST38, the high-density depth image forming system 200 determines whether the target frame is the last frame. When the target frame is not the last frame, the high-density depth image forming system 200 designates the next frame as the target frame in step ST39, and then returns the flow to the processing in step ST32 to repeat processing similar to the processing described above and obtain the high-density depth image DI-3 of the target frame from which the occlusion region has been removed.

When the target frame is the last frame in step ST38, the high-density depth image forming system 200 ends processing in step ST40.

As described above, the high-density depth image forming system 200 illustrated in FIG. 3 generates a high-density point cloud by projecting LiDAR point clouds each corresponding to the non-moving body region on the same coordinate system, such as the world coordinate system and sequentially merging the LiDAR point clouds for a plurality of frames. Accordingly, a preferable high-density three-dimensional environment (high-density point cloud) from which a moving body region has been removed can be constructed. Moreover, in this case, the three-dimensional environment is constructed using LiDAR point clouds. Accordingly, preferable construction of a high-density three-dimensional environment from which a moving body region has been removed is achievable even in an environment containing no pattern, such as a white wall.

Furthermore, the high-density depth image forming system 200 illustrated in FIG. 3 detects an occlusion region on the basis of comparison between the depth image DI-1 formed by projecting a high-density point cloud from which a moving body region has been removed on a camera image plane of a target frame which is at least any one of a plurality of frames, and the depth image DI-2 formed using a camera image of the target frame according to the optical flow, and extracts a depth of a region corresponding to the camera image of the target frame and not corresponding to the occlusion region, from among the depths of the depth image DI-1 to obtain the high-density depth image DI-3 of the target frame. Accordingly, a preferable high-density depth image from which the moving body region and the occlusion region have been removed can be obtained.

### 3. Third Embodiment

### [High-Density Depth Image Forming System]

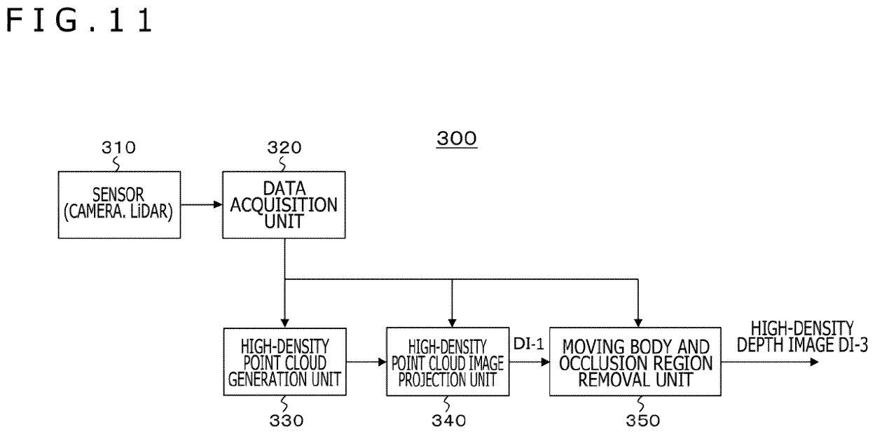

FIG. 11 illustrates a configuration example of a high-density depth image forming system 300 according to the third embodiment. For example, the high-density depth image forming system 300 in this example is mounted and used on an independent moving body such as a vehicle and a robot. Unlike the high-density depth image forming system 200 described above and illustrated in FIG. 3, the high-density depth image forming system 300 in this example generates a high-density point cloud without removing a moving body region, and collectively removes regions of a moving body and an occlusion in a final stage.

The high-density depth image forming system 300 includes a sensor 310, a data acquisition unit 320, a high-density point cloud generation unit 330, a high-density point cloud image projection unit 340, and a moving body and occlusion region removal unit 350.

The sensor 310 includes at least a camera and a LiDAR (Light Detection And Ranging) sensor. The data acquisition unit 320 acquires and retains data obtained by the sensor 310 for each frame, or a camera image and a LiDAR point cloud in this embodiment.

The high-density point cloud generation unit 330 projects LiDAR point clouds of a plurality of frames from a trajectory of the independent moving body to the same coordinate system, such as a world coordinate system defined on the basis of a certain position, in a manner similar to the manner of PTL 2 described above, and sequentially merges the LiDAR point clouds to generate a high-density point cloud. Note herein that the trajectory of the independent moving body may be a trajectory acquired by a GPS and an IMU, or a trajectory estimated by a camera or a LiDAR sensor.

The high-density point cloud image projection unit 340 designates at least any one of a plurality of frames handled by the high-density point cloud generation unit 330 described above as a target frame, and carries out projection on a camera image plane of this target frame to form the depth image DI-1 of the target frame. The depth image DI-1 includes a depth error caused by a moving body or an occlusion.

The moving body and occlusion region removal unit 350 removes regions of the moving body and the occlusion from the depth image DI-1 of the target frame formed by the high-density point cloud image projection unit 340 to obtain the high-density depth image DI-3 of the target frame from which the regions of the moving body and the occlusion have been removed.

In this case, the moving body and occlusion region removal unit 350 initially performs processing similar to the processing performed by the moving body detection device 120 of the moving body detecting system 100 described above and illustrated in FIG. 1 to detect the regions of the moving body and the occlusion region. Specifically, the moving body and occlusion region removal unit 350 forms the depth image DI-2 by using a camera image of the target frame according to the optical flow, and compares the depth image DI-2 with the depth image DI-1 of the target frame formed by the high-density point cloud image projection unit 340 to detect the regions of the moving body and the occlusion.

In this case, the moving body and occlusion region removal unit 350 sequentially designates each of the depths d1 of the depth image DI-1 of the target frame formed by the high-density point cloud image projection unit 340 as a processing target. When a relative error of the depth d1 located at the same image position (coordinates) as the image position of any one of the depths d2 of the depth image DI-2 formed using the camera image of the target frame according to the optical flow is larger than a threshold, the moving body and occlusion region removal unit 350 detects the image position of this depth d1 as the regions of the moving body and the occlusion. Note herein that the relative error is a value obtained by dividing an absolute value of a difference between the depth d1 and the depth d2 by the depth d1, for example.

Thereafter, the moving body and occlusion region removal unit 350 subsequently extracts the depth d1 of the region corresponding to the camera image of the target frame and not corresponding to the regions of the moving body and the occlusion, from among the depths d1 of the depth image DI-1 of the target frame formed by the high-density point cloud image projection unit 340 to obtain the high-density depth image DI-3 of the target frame from which the regions of the moving body and the occlusion have been removed. Note herein that the depth d1 of the depth image DI-1 corresponding to the camera image of the target frame refers to the depth d1 located at the same image position (coordinates) as the image position of any one of the depths d2 of the depth image DI-2, and therefore refers to the depth d1 contained in the camera image region.

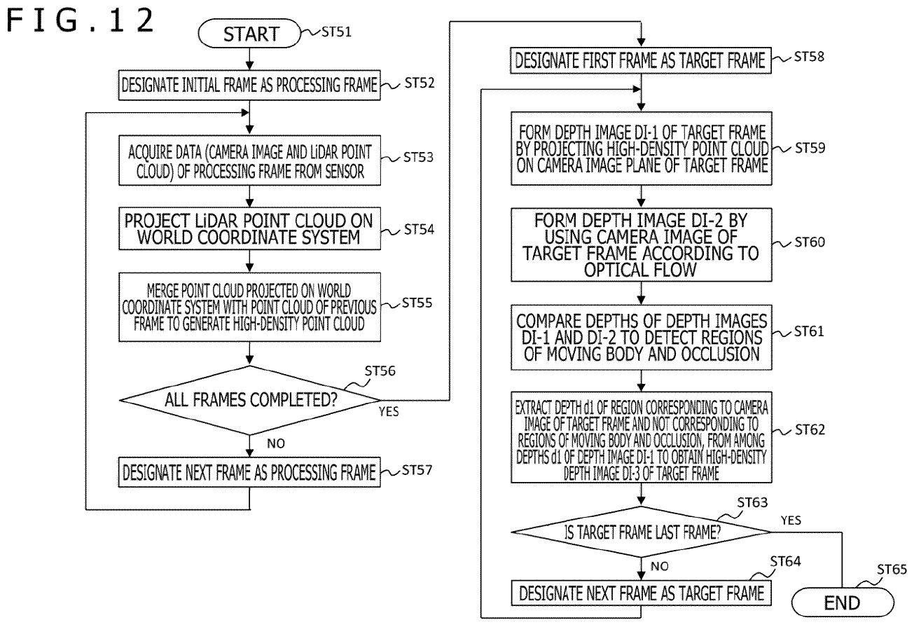

A flowchart in FIG. 12 illustrates an example of processing procedures performed by the high-density depth image forming system 300 for forming a high-density depth image. This example is a use case of the first method which generates a high-density point cloud by using data of all frames acquired by the data acquisition unit 320 from the sensor 310 (see FIG. 5).

In step ST51, the high-density depth image forming system 300 starts processing. In subsequent step ST52, the high-density depth image forming system 300 designates an initial frame as a processing frame.

In subsequent step ST53, the high-density depth image forming system 300 causes the data acquisition unit 320 to acquire data (a camera image and a LiDAR point cloud) of the processing frame from the sensor 310. In subsequent step ST54, the high-density depth image forming system 300 causes the high-density point cloud generation unit 330 to project the LiDAR point cloud on a world coordinate system. In subsequent step ST55, the high-density depth image forming system 300 causes the high-density point cloud generation unit 330 to merge the point cloud projected on the world coordinate system with a point cloud of a previous frame to form a high-density point cloud.

In subsequent step ST56, the high-density depth image forming system 300 determines whether processing has been completed for all the frames. When processing is not completed for all the frames, the high-density depth image forming system 300 shifts the processing to a next frame in step ST57. After completion of this processing in step ST57, the high-density depth image forming system 300 returns the flow to step ST53 to repeat processing similar to the processing described above.

When processing for all the frames is completed in step ST56, i.e., when high-density point clouds are generated using data of all the frames acquired by the data acquisition unit 320 from the sensor 310, the high-density depth image forming system 300 designates the first frame as the target frame in step ST58.

In subsequent step ST59, the high-density depth image forming system 300 causes the high-density point cloud image projection unit 340 to project the high-density point cloud on the camera image plane of the target frame to form the depth image DI-1 of the target frame. In subsequent step ST60, the high-density depth image forming system 300 causes the moving body and occlusion region removal unit 350 to form the depth image DI-2 by using the camera image of the target frame according to the optical flow.

In subsequent step ST61, the high-density depth image forming system 300 causes the moving body and occlusion region removal unit 350 to compare the depth image DI-1 and the depth image DI-2 to detect regions of a moving body and an occlusion. When the relative error |d1−d2|/d1 is larger than a threshold in this step concerning the depth d1 which is included in the respective depths d1 of the depth image DI-1 each sequentially designated as the processing target and is located at the same image position (coordinates) as the image position of any one of the depths d2 of the depth image DI-2, the moving body and occlusion region removal unit 350 detects the image position of this depth d1 as the regions of the moving body and the occlusion.

In subsequent step ST62, the high-density depth image forming system 300 causes the moving body and occlusion region removal unit 350 to extract the depth d1 of the region corresponding to the camera image of the target frame and not corresponding to the regions of the moving body and the occlusion, from among the depths d1 of the depth image DI-1 to obtain the high-density depth image DI-3 of the target frame from which the regions of the moving body and the occlusion have been removed.

In subsequent step ST63, the high-density depth image forming system 300 determines whether the target frame is the last frame. Note that the last frame may be the Nth frame associated with generation of the high-density point cloud illustrated in FIG. 5, or may be a frame before the Nth frame.

When the target frame is not the last frame, the high-density depth image forming system 300 designates the next frame as the target frame in step ST64, and then returns the flow to the processing in step ST59 to repeat processing similar to the processing described above and obtain the high-density depth image DI-3 of the target frame from which the regions of the moving body and the occlusion have been removed.

When the target frame is the last frame in step ST63, the high-density depth image forming system 300 ends processing in step ST65.

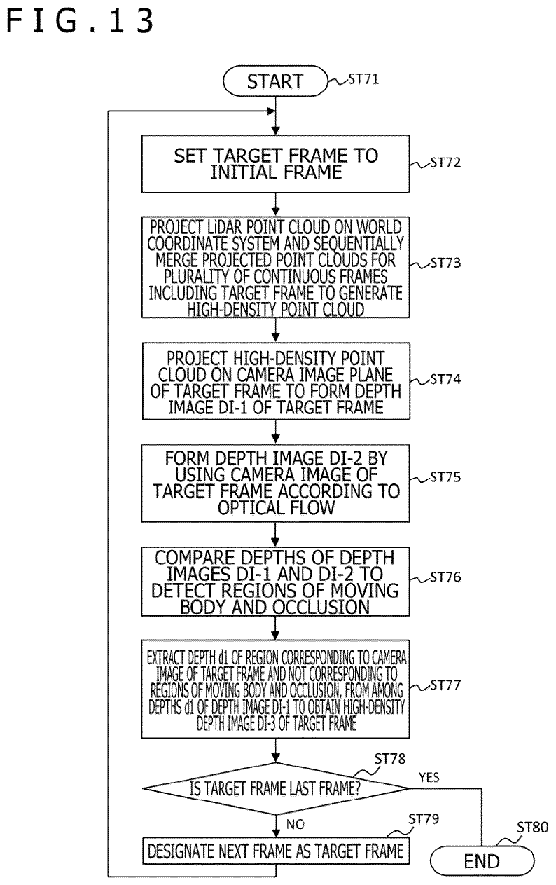

A flowchart in FIG. 13 illustrates a different example of processing procedures performed by the high-density depth image forming system 300 for forming a high-density depth image. This example is a use case of the second method which generates a high-density point cloud by sequentially using data of a predetermined number of frames acquired by the data acquisition unit 320 from the sensor 310 (see FIGS. 6, 7, and 8).

In step ST71, the high-density depth image forming system 300 starts processing. In subsequent step ST72, the high-density depth image forming system 300 sets the initial frame as the target frame. For example, the initial frame in the case illustrated in FIG. 6 is the sixth frame, the initial frame in the case illustrated in FIG. 7 is the sixth frame, and the initial frame in the case illustrated in FIG. 8 is the first frame.

In subsequent step ST73, the high-density depth image forming system 300 causes the high-density point cloud generation unit 330 to project LiDAR point clouds on the world coordinate system for a plurality of continuous frames including the target frame, and sequentially merge the projected LiDAR point clouds to generate a high-density point cloud.

In subsequent step ST74, the high-density depth image forming system 300 causes the high-density point cloud image projection unit 340 to project the high-density point cloud on the camera image plane of the target frame to form the depth image DI-1 of the target frame. In subsequent step ST75, the high-density depth image forming system 300 causes the moving body and occlusion region removal unit 350 to form the depth image DI-2 by using the camera image of the target frame according to the optical flow.

In subsequent step ST76, the high-density depth image forming system 300 causes the moving body and occlusion region removal unit 350 to compare the depth image DI-1 and the depth image DI-2 to detect regions of a moving body and an occlusion. When the relative error |d1−d2|/d1 is larger than a threshold in this step concerning the depth d1 which is included in the respective depths d1 of the depth image DI-1 sequentially designated as the processing target and is located at the same image position (coordinates) as the image position of any one of the depths d2 of the depth image DI-2, the moving body and occlusion region removal unit 350 detects the image position of this depth d1 as the regions of the moving body and the occlusion.

In subsequent step ST77, the high-density depth image forming system 300 causes the moving body and occlusion region removal unit 350 to extract the depth d1 of the region corresponding to the camera image of the target frame and not corresponding to the regions of the moving body and the occlusion, from among the depths d1 of the depth image DI-1 to obtain the high-density depth image DI-3 of the target frame from which the regions of the moving body and the occlusion have been removed.

In subsequent step ST78, the high-density depth image forming system 300 determines whether the target frame is the last frame. When the target frame is not the last frame, the high-density depth image forming system 300 designates the next frame as the target frame in step ST79, and then returns the flow to the processing in step ST72 to repeat processing similar to the processing described above and obtain the high-density depth image DI-3 of the target frame from which the regions of the moving body and the occlusion have been removed.

When the target frame is the last frame in step ST78, the high-density depth image forming system 300 ends processing in step ST80.

As described above, the high-density depth image forming system 300 illustrated in FIG. 11 forms a high-density point cloud by projecting LiDAR point clouds on the same coordinate system, such as a world coordinate system and sequentially merging the LiDAR point clouds, detects regions of a moving body and an occlusion on the basis of depth comparison between the depth image DI-1 formed by projecting the high-density point cloud on a camera image plane of a target frame which is at least any one of a plurality of frames, and the depth image DI-2 formed using a camera image of the target frame according to the optical flow, and extracts a depth of a region corresponding to the camera image of the target frame and not corresponding to the regions of the moving body and the occlusion from the depths of the depth image DI-1 to obtain the high-density depth image DI-3 of the target frame. Accordingly, a preferable high-density depth image from which the moving body region and the occlusion region have been removed can be obtained.

Moreover, the high-density depth image forming system 300 illustrated in FIG. 11 generates a high-density point cloud without removing a moving body region, and collectively removes regions of a moving body and an occlusion in a final stage to obtain the high-density depth image DI-3. Accordingly, even though a part of the depths of the occlusion region produced by the moving body are lost, the entire processing time can be reduced by simplification of the processing.

### 4. Fourth Embodiment

### [Data Collecting System]

Each of the high-density depth image forming systems 200 and 300 described above and illustrated in FIGS. 3 and 11, respectively, is capable of automatically forming high-density depth images, and therefore is capable of constructing a system which automatically collects learning images and performs learning.

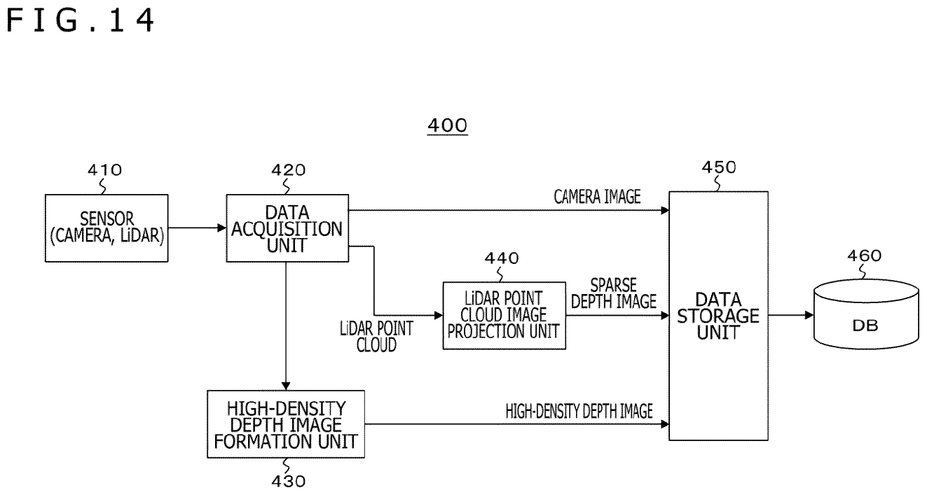

FIG. 14 illustrates a configuration example of a data collecting system 400 according to the fourth embodiment. For example, the data collecting system 400 in this example is mounted and used on an independent moving body such as a vehicle and a robot.

The data collecting system 400 in this example includes a sensor 410, a data acquisition unit 420, a high-density depth image formation unit 430, a LiDAR point cloud image projection unit 440, a data storage unit 450, and a database 460.

The sensor 410 includes at least a camera and a LiDAR (Light Detection And Ranging) sensor. The data acquisition unit 420 acquires and retains data obtained by the sensor 410 for each frame, or a camera image and a LiDAR point cloud in this embodiment.

While a detailed configuration is not explained herein, the high-density depth image formation unit 430 is configured in a manner similar to the manners of the high-density depth image forming systems 200 and 300 described above and illustrated in FIGS. 3 and 11, and forms a high-density depth image of a target frame.

While not described in detail herein, the LiDAR point cloud image projection unit 440 projects a LiDAR point cloud of a target frame on the camera image plane of the target frame in a manner similar to the manner of the LiDAR point cloud image projection unit 122 included in the moving body detection device 120 of the moving body detecting system 100 described above and illustrated in FIG. 1 to form a sparse depth image in a camera coordinate system. In this case, the depth image to be obtained is a sparse image because the LiDAR point cloud of one frame is projected on the camera image plane.

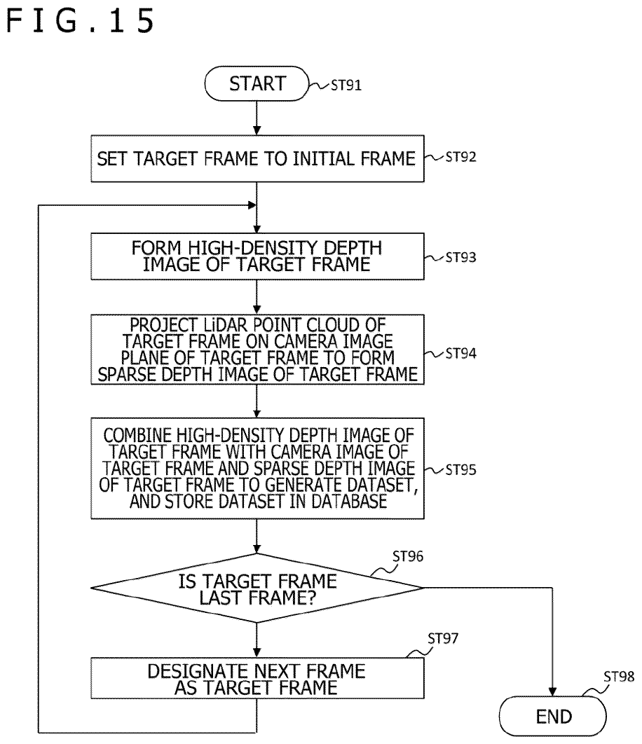

The data storage unit 450 combines the high-density depth image of the target frame formed by the high-density depth image formation unit 430 with the camera image of the target frame retained in the data acquisition unit 420, and the sparse depth image of the target frame formed by the LiDAR point cloud image projection unit 440 to generate a dataset, and stores the dataset in the database 460. A flowchart in FIG. 15 illustrates an example of processing procedures performed by the data collecting system 400 for collecting data.

In step ST91, the data collecting system 400 starts processing. In subsequent step ST92, the data collecting system 400 sets an initial frame as a target frame. For example, the initial frame in the case illustrated in FIG. 5 is the first frame, the initial frame in the case illustrated in FIG. 6 is the sixth frame, the initial frame in the case illustrated in FIG. 7 is the sixth frame, and the initial frame in the case illustrated in FIG. 8 is the first frame.

In subsequent step ST93, the data collecting system 400 causes the high-density depth image formation unit 430 to form a high-density depth image of the target frame. In subsequent step ST94, the data collecting system 400 causes the LiDAR point cloud image projection unit 440 to project the LiDAR point cloud of the target frame on the camera image plane of the target frame to form a sparse depth image of the target frame.

In subsequent step ST95, the data collecting system 400 causes the data storage unit 450 to combine the high-density depth image of the target frame with the camera image of the target frame and the sparse depth image of the target frame to generate a dataset, and store the dataset in the database 460.

In subsequent step ST96, the data collecting system 400 determines whether the target frame is the last frame. When the target frame is not the last frame, the data collecting system 400 designates the next frame as the target frame in step ST97, and then returns the flow to the processing in step ST93 to repeat processing similar to the processing described above, generate a dataset of the target frame, and store the dataset in the database 460.

Meanwhile, when the target frame is the last frame in step ST96, the data collecting system 400 ends processing in step ST98.

As described above, the high-density depth image forming system 400 illustrated in FIG. 14 is capable of storing, in the database 460, datasets including high-density depth images, camera images, and sparse depth images corresponding to a plurality of frames.

It is to be noted that, according to the data collecting system 400 illustrated in FIG. 14 and presented by way of example, although the dataset includes a high-density depth image, a camera image, and a sparse depth image, the dataset may include a high-density depth image, a camera image, and a LiDAR point cloud.

### 5. Fifth Embodiment

### [Learning System]

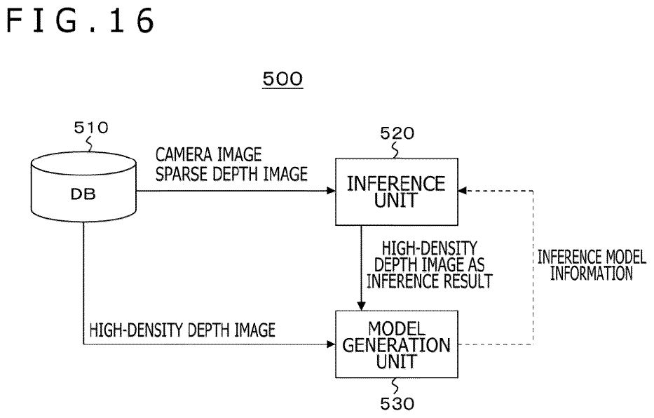

FIG. 16 illustrates a configuration example of a learning system 500 according to the fifth embodiment. For example, the learning system 500 in this example is mounted and used on an independent moving body such as a vehicle and a robot.

The learning system 500 includes a database 510, an inference unit 520, and a model generation unit 530.

The database 510 stores datasets corresponding to a plurality of frames collected by the data collecting system 400 described above and illustrated in FIG. 14, or datasets each including a high-density depth image, a camera image, and a sparse depth image in this embodiment.

The inference unit 520 obtains a high-density depth image as an inference result on the basis of a camera image and a sparse depth image of a given dataset stored in the database 510 according to inference using an inference model. The model generation unit 530 calculates a loss of the high-density depth image as the inference result by using the high-density depth image of the given dataset described above and stored in the database 510, and updates the inference model on the basis of the loss calculation result.

In this manner, the inference model updated by the model generation unit 530 is reflected in the inference unit 520, and similar processing is repeated by the inference unit 520 and the model generation unit 530 for a next dataset stored in the database 510 to update the inference model. Accordingly, learning develops with sequential update of the inference model for reducing losses.

Note that learning may be performed either at the time of data collection during movement of the independent moving body, or at a stop of the independent moving body after completion of data collection.

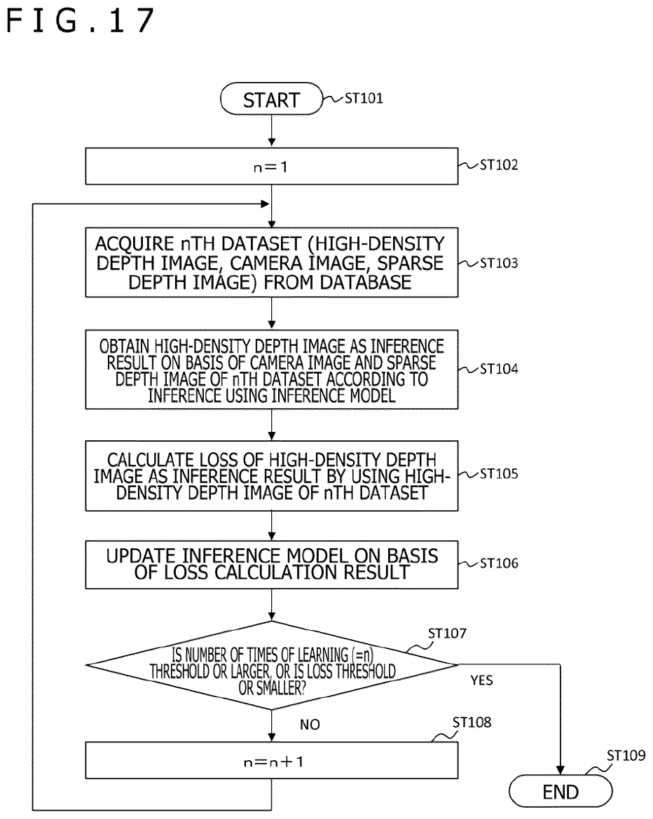

A flowchart in FIG. 17 illustrates an example of processing procedures performed by the learning system 500 for learning.

In step ST101, the learning system 500 starts processing. In subsequent step ST102, the learning system 500 sets n to 1.

In subsequent step ST103, the learning system 500 acquires an nth dataset from the database 510. This dataset contains a high-density depth image, a camera image, and a sparse depth image.

In subsequent step ST104, the learning system 500 causes the inference unit 520 to obtain a high-density depth image as an inference result on the basis of the camera image and the sparse depth image of the nth dataset according to inference using an inference model.

In subsequent step ST105, the learning system 500 causes the model generation unit 530 to calculate a loss of the high-density depth image as the inference result by using the high-density depth image of the nth dataset. In subsequent step ST106, the learning system 500 causes the model generation unit 530 to update the inference model on the basis of the loss calculation result.

In subsequent step ST107, the learning system 500 determines whether the number of times of learning, i.e., n is larger than or equal to a threshold, or whether the loss is smaller than or equal to a threshold. When the number of times of learning is not larger than or equal to the threshold, or the loss is not smaller than or equal to the threshold, the learning system 500 sets n to n+1 in step ST108, and then returns the flow to the processing in step ST103 to repeat a learning process similar to the learning process described above.

Meanwhile, when the number of times of learning is larger than or equal to the threshold, or the loss is smaller than or equal to the threshold in step ST107, the learning system 500 ends the process in step ST109.

As described above, the learning system 500 illustrated in FIG. 16 is capable of generating a preferable inference model for obtaining a high-density depth image as an inference result on the basis of a camera image and a sparse depth image.

### 6. Sixth Embodiment

### [High-Density Depth Image Inference System]

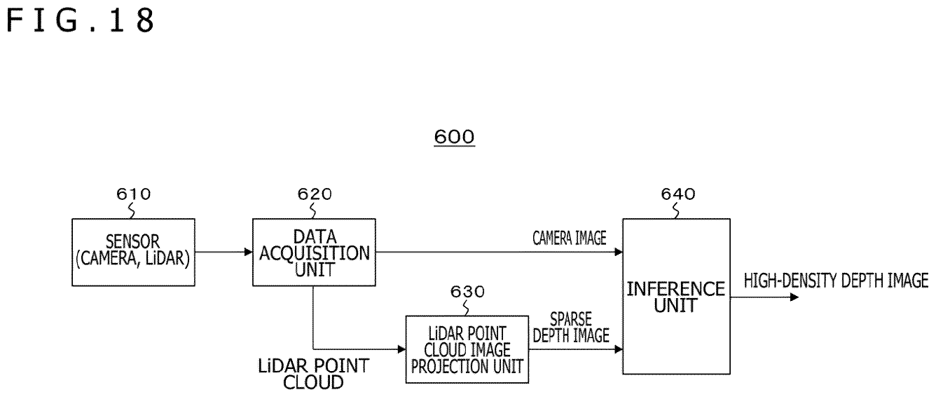

FIG. 18 illustrates a configuration example of a high-density depth image inference system 600 according to the sixth embodiment. For example, the high-density depth image inference system 600 in this example is mounted and used on an independent moving body such as a vehicle and a robot.

The high-density depth image inference system 600 includes a sensor 610, a data acquisition unit 620, a LiDAR point cloud image projection unit 630, and an inference unit 640.

The sensor 610 includes at least a camera and a LiDAR (Light Detection And Ranging) sensor. The data acquisition unit 620 acquires and retains data obtained by the sensor 610 for each frame, or a camera image and a LiDAR point cloud in this embodiment.

While not described in detail herein, the LiDAR point cloud image projection unit 630 projects a LiDAR point cloud acquired by the data acquisition unit 620 on a camera image plane for each frame in a manner similar to the manner of the LiDAR point cloud image projection unit 440 of the data collecting system 400 described above and illustrated in FIG. 14 to form a sparse depth image in a camera coordinate system.

The inference unit 640 includes an inference model learned by using the learning system 500 described above and illustrated in FIG. 16. The inference unit 640 obtains a high-density depth image as an inference result for each frame on the basis of a camera image acquired by the data acquisition unit 620 and a sparse depth image formed by the LiDAR point cloud image projection unit 630 according to inference using an inference model.

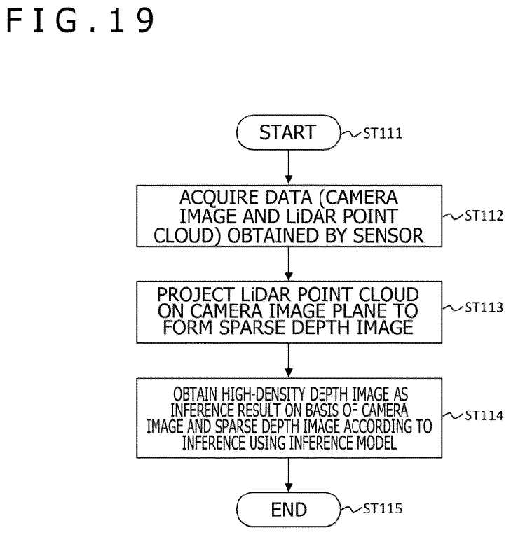

A flowchart in FIG. 19 illustrates an example of processing procedures performed by the high-density depth image inference system 600 for inferring a high-density depth image for each frame.

In step ST111, the high-density depth image inference system 600 starts processing. In subsequent step ST112, the high-density depth image inference system 600 causes the data acquisition unit 620 to acquire data (a camera image and a LiDAR point cloud) obtained by the sensor 610.

In subsequent step ST113, the high-density depth image inference system 600 causes the LiDAR point cloud image projection unit 630 to project the LiDAR point cloud on the camera image plane to form a sparse depth image.

In subsequent step ST114, the high-density depth image inference system 600 causes the inference unit 640 to obtain a high-density depth image as an inference result on the basis of the camera image and the sparse depth image according to inference using an inference model. In subsequent step ST115, the high-density depth image inference system 600 ends processing.

The high-density depth image inference system 600 illustrated in FIG. 18 constitutes a high-density depth image inference system capable of achieving self-learning by using a series of systems such as the high-density depth image forming systems 200 and 300 illustrated in FIGS. 3 and 11, the data collecting system 400 illustrated in FIG. 14, and the learning system 500 illustrated in FIG. 16, and can achieve formation of highly accurate high-density depth images even in an unknown environment. Generally, a longer time is required for LiDAR to acquire data as density increases, and it is therefore difficult to carry out high-density observation in real-time. However, the high-density depth image inference system 600 described above can increase density of sparse LiDAR point clouds, and therefore can implement high-density and high-precision distance measurement in real-time.

### “Processing by Software of Computer”

The processes presented in the flowcharts described above and illustrated in FIGS. 2, 9, 10, 12, 13, 15, 17, and 19 may be executed by hardware or by software. In a case where a series of the processes are executed by software, a program constituting this software is installed from a recording medium into a computer incorporated in dedicated hardware, a computer capable of executing various functions under installed various programs, such as a general-purpose computer, or the like.

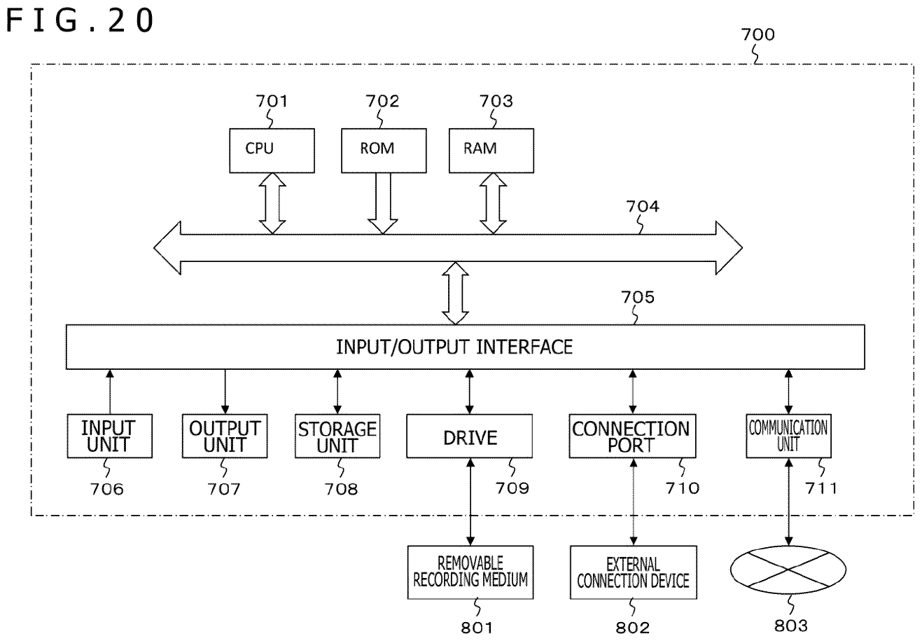

FIG. 20 is a block diagram illustrating a hardware configuration example of a computer 700. The computer 700 includes a CPU 701, a ROM 702, a RAM 703, a bus 704, an input/output interface 705, an input unit 706, an output unit 707, a storage unit 708, a drive 709, a connection port 710, and a communication unit 711. Note that the hardware configuration illustrated herein is presented only by way of example, and therefore may eliminate a part of the constituent elements. Moreover, the hardware configuration may further include configuration elements other than the configuration elements presented herein.

For example, the CPU 701 functions as an arithmetic processing device or a control device, and controls entire or a part of operations of the respective constituent elements under various programs recorded in the ROM 702, the RAM 703, the storage unit 708, or a removable recording medium 801.

The ROM 702 is means for storing programs to be read into the CPU 701, data used for arithmetic processing, and the like. For example, the RAM 703 temporarily or permanently stores programs read into the CPU 701, various parameters variable as necessary at the time of execution of these programs, and the like.

The CPU 701, the ROM 702, and the RAM 703 are connected to one another via the bus 704. Meanwhile, various constituent elements are connected to the bus 704 via the interface 705.

For example, the input unit 706 includes a mouse, a keyboard, a touch panel, a button, a switch, a lever, or the like. Moreover, the input unit 706 may be a remote controller (hereinafter referred to as a remote) capable of transmitting control signals by using infrared rays or other radio waves.

For example, the output unit 707 is a device capable of notifying a user of acquired information in a visual or auditory manner, such as a display device constituting a CRT (Cathode Ray Tube), an LCD, an organic EL, or the like, an audio output device constituting a speaker, a headphone, or the like, a printer, a cellular phone, and a facsimile machine.

The storage unit 708 is a device for storing various types of data. For example, the storage unit 708 may be a magnetic storage device such as a hard disk drive (HDD), a semiconductor storage device, an optical storage device, a magneto-optical storage device, or the like.

For example, the drive 709 is a device for reading information recorded in the removable recording medium 801 such as a magnetic disk, an optical disk, a magneto-optical disk, and a semiconductor memory, or for writing information into the removable recording medium 801.

For example, the removable recording medium 801 is a DVD medium, a Blu-ray (registered trademark) medium, an HD DVD medium, various types of semiconductor storage media, or the like. Needless to say, for example, the removable recording medium 801 may be an IC card equipped with a contactless IC chip, an electronic device, or the like.

For example, the connection port 710 is a port for connecting with an external connection device 802, such as a USB (Universal Serial Bus) port, an IEEE1394 port, an SCSI (Small Computer System Interface), an RS-232C port, and an optical audio terminal. For example, the external connection device 802 is a printer, a portable music player, a digital camera, a digital video camera, an IC recorder, or the like.

The communication unit 711 is a communication device for connecting with a network 803, such as a wired or wireless LAN, a communication card for Bluetooth (registered trademark) or WUSB (Wireless USB), a router for optical communication, a router for ADSL (Asymmetric Digital Subscriber Line), and a modem for various types of communication.

Note that the programs executed by the computer may be programs where processing is performed in time series in the order explained in the present description or where processing is performed in parallel or at necessary timing such as an occasion of a call.

### 7. Modifications

While the preferred embodiments of the present disclosure have been described in detail with reference to the accompanying drawings, the technical range of the present disclosure is not limited to these examples. It is apparent that various modifications or correction examples within the scope of the technical spirit described in the claims can occur to those having ordinary knowledge in the technical field of the present disclosure. It is therefore understood that these modifications and corrections obviously belong to the technical range of the present disclosure.

Moreover, advantageous effects described in the present description are not given as limited effects, but presented only for explanatory or exemplary purposes. In other words, the technology according to the present disclosure can offer other advantageous effects apparent for those skilled in the art in the light of the explanation of the present description in addition to or instead of the advantageous effects described above.

The present technology can also adopt the following configurations.

(1)

An information processing device including:
a processing unit that performs
   a process that forms a first depth image by projecting a LiDAR point cloud on a camera image plane,
   a process that forms a second depth image by using a camera image according to an optical flow, and
   a process that compares the first depth image and the second depth image to detect a moving body region or a non-moving body region.
      (2)

The information processing device according to (1) above, in which, when a relative error of a depth included in depths of the first depth image and located at an image position identical to an image position of a depth of the second depth image is larger than a threshold in the process that detects the moving body region, the processing unit detects the image position of the corresponding depth of the first depth image as the moving body region.

(3)

The information processing device according to (2) above, in which the relative error is a value obtained by dividing an absolute value of a difference between a depth of the first depth image and a depth of the second depth image by the depth of the first depth image.

(4)

The information processing device according to (1) above, in which, when a relative error of a depth included in depths of the first depth image and located at an image position identical to an image position of a depth of the second depth image is smaller than or equal to a threshold in the process that detects the non-moving body region, the processing unit detects the image position of the corresponding depth of the first depth image as the non-moving body region.

(5)

The information processing device according to (4) above, in which the relative error is a value obtained by dividing an absolute value of a difference between a depth of the first depth image and a depth of the second depth image by the depth of the first depth image.

(6)

The information processing device according to any one of (1), (4), and (5) above, in which the processing unit further performs a process that projects the LiDAR point clouds corresponding to the non-moving body regions of a plurality of frames on an identical coordinate system, and sequentially merges the LiDAR point clouds to generate a high-density point cloud.

(7)

The information processing device according to (6) above, in which the processing unit further performs
a process that forms a third depth image by designating at least any one of the plurality of frames as a target frame and projecting the high-density point cloud on a camera image plane of the target frame,
a process that forms a fourth depth image by using a camera image of the target frame according to the optical flow,
a process that compares the third depth image and the fourth depth image to detect an occlusion region, and
a process that extracts a depth of a region corresponding to the camera image of the target frame and not corresponding to the occlusion region, from among depths of the third depth image to obtain a high-density depth image of the target frame.
   (8)

The information processing device according to (7) above, in which, when a relative error of a depth included in the depths of the third depth image and located at an image position identical to an image position of a depth of the fourth depth image is larger than a threshold in the process that detects the occlusion region, the processing unit detects the image position of the corresponding depth of the third depth image as the occlusion region.

(9)

The information processing device according to (8) above, in which the relative error is a value obtained by dividing an absolute value of a difference between a depth of the third depth image and a depth of the fourth depth image by the depth of the third depth image.

(10)

The information processing device according to any one of (7) to (9) above, in which, by using the high-density depth images corresponding to a plurality of the frames and obtained by the process that obtains the high-density depth image of the target frame, the processing unit further performs a process that generates datasets including sparse depth images obtained by projecting the high-density depth images, the camera images, and the LiDAR point clouds corresponding to the plurality of frames on the camera image plane, and stores the datasets in a database.

(11)

The information processing device according to (10) above, in which the processing unit further performs a process that generates an inference model for obtaining the high-density depth images from the camera images and the sparse depth images on the basis of the datasets corresponding to the plurality of frames and stored in the database.

(12)

An information processing method including:
a procedure that forms a first depth image by projecting a LiDAR point cloud on a camera image plane;
a procedure that forms a second depth image by using a camera image according to an optical flow; and
a procedure that compares the first depth image and the second depth image to detect a moving body region or a non-moving body region.
   (13)

A program for causing a computer to execute an information processing method including:
a procedure that forms a first depth image by projecting a LiDAR point cloud on a camera image plane;
a procedure that forms a second depth image by using a camera image according to an optical flow; and
a procedure that compares the first depth image and the second depth image to detect a moving body region or a non-moving body region.
   (14)

An information processing device including:
a processing unit that performs
   a process that generates a high-density point cloud by projecting LiDAR point clouds of a plurality of frames on an identical coordinate system and sequentially merging the LiDAR point clouds,
   a process that forms a first depth image by designating at least any one of the plurality of frames as a target frame and projecting the high-density point cloud on a camera image plane of the target frame,
   a process that forms a second depth image by using a camera image of the target frame according to an optical flow,
   a process that compares the first depth image and the second depth image to detect regions of a moving body and an occlusion, and
   a process that extracts a depth of a region corresponding to the camera image of the target frame and not corresponding to the regions of the moving body and the occlusion from depths of the first depth image to obtain a high-density depth image of the target frame.
      (15)

The information processing device according to (14) above, in which, when a relative error of a depth included in depths of the first depth image and located at an image position identical to an image position of a depth of the second depth image is larger than a threshold in the process that detects the regions of the moving body and the occlusion, the processing unit detects the image position of the corresponding depth of the first depth image as the regions of the moving body and the occlusion.

(16)

The information processing device according to (15) above, in which the relative error is a value obtained by dividing an absolute value of a difference between a depth of the first depth image and a depth of the second depth image by the depth of the first depth image.

(17)

The information processing device according to any one of (14) to (16) above, in which, by using the high-density depth images corresponding to a plurality of the frames and obtained by the process that obtains the high-density depth image of the target frame, the processing unit further performs a process that generates datasets including sparse depth images obtained by projecting the high-density depth images, the camera images, and the LiDAR point clouds corresponding to the plurality of frames on the camera image plane, and stores the datasets in a database.

(18)

The information processing device according to (17) above, in which the processing unit further performs a process that generates an inference model for obtaining the high-density depth images from the camera images and the sparse depth images on the basis of the datasets corresponding to the plurality of frames and stored in the database.

(19)

An information processing method including:
a procedure that generates a high-density point cloud by projecting LiDAR point clouds of a plurality of frames on an identical coordinate system and sequentially merging the LiDAR point clouds;
a procedure that forms a first depth image by designating at least any one of the plurality of frames as a target frame and projecting the high-density point cloud on a camera image plane of the target frame;
a procedure that forms a second depth image by using a camera image of the target frame according to an optical flow;
a procedure that compares the first depth image and the second depth image to detect regions of a moving body and an occlusion; and
a procedure that extracts a depth corresponding to the camera image of the target frame and not corresponding to the regions of the moving body and the occlusion from depths of the first depth image to obtain a high-density depth image of the target frame.
   (19)

A program for causing a computer to execute an information processing method including:
a procedure that generates a high-density point cloud by projecting LiDAR point clouds of a plurality of frames on an identical coordinate system and sequentially merging the LiDAR point clouds;
a procedure that forms a first depth image by designating at least any one of the plurality of frames as a target frame and projecting the high-density point cloud on a camera image plane of the target frame;
a procedure that forms a second depth image by using a camera image of the target frame according to an optical flow;
a procedure that compares the first depth image and the second depth image to detect regions of a moving body and an occlusion; and
a procedure that extracts a depth of a region corresponding to the camera image of the target frame and not corresponding to the regions of the moving body and the occlusion from depths of the first depth image to obtain a high-density depth image of the target frame.

### REFERENCE SIGNS LIST

100: Moving body detecting system
110: Sensor
120: Moving body detection device
121: Data acquisition unit
122: LiDAR point cloud image projection unit
123: Motion depth estimation unit
124: Moving body region detection unit
130: Moving body notification device
200: High-density depth image forming system
210: Sensor
220: Data acquisition unit
230: Non-moving body detection unit
231: LiDAR point cloud image projection unit
232: Motion depth estimation unit
233: Non-moving body region detection unit
240: High-density point cloud generation unit
250: High-density point cloud image projection unit
260: Occlusion region removal unit
300: High-density depth image forming system
310: Sensor
320: Data acquisition unit
330: High-density point cloud generation unit
340: High-density point cloud image projection unit
350: Moving body and occlusion region removal unit
400: Data collecting system
410: Sensor
420: Data acquisition unit
430: High-density depth image formation unit
440: LiDAR point cloud image projection unit
450: Data storage unit
460: Database
500: Learning system
510: Database
520: Inference unit
530: Model generation unit
600: High-density depth image inference system
610: Sensor
620: Data acquisition unit
630: LiDAR point cloud image projection unit
640: Inference unit
700: Computer

1. An information processing device comprising:
a processing unit that performs
a process that forms a first depth image by projecting a LiDAR point cloud on a camera image plane,
a process that forms a second depth image by using a camera image according to an optical flow, and
a process that compares the first depth image and the second depth image to detect a moving body region or a non-moving body region.

2. The information processing device according to claim 1, wherein, when a relative error of a depth included in depths of the first depth image and located at an image position identical to an image position of a depth of the second depth image is larger than a threshold in the process that detects the moving body region, the processing unit detects the image position of the corresponding depth of the first depth image as the moving body region.

3. The information processing device according to claim 2, wherein the relative error is a value obtained by dividing an absolute value of a difference between a depth of the first depth image and a depth of the second depth image by the depth of the first depth image.

4. The information processing device according to claim 1, wherein, when a relative error of a depth included in depths of the first depth image and located at an image position identical to an image position of a depth of the second depth image is smaller than or equal to a threshold in the process that detects the non-moving body region, the processing unit detects the image position of the corresponding depth of the first depth image as the non-moving body region.

5. The information processing device according to claim 4, wherein the relative error is a value obtained by dividing an absolute value of a difference between a depth of the first depth image and a depth of the second depth image by the depth of the first depth image.

6. The information processing device according to claim 1, wherein the processing unit further performs a process that projects the LiDAR point clouds corresponding to the non-moving body regions of a plurality of frames on an identical coordinate system, and sequentially merges the LiDAR point clouds to generate a high-density point cloud.

7. The information processing device according to claim 6, wherein the processing unit further performs
a process that forms a third depth image by designating at least any one of the plurality of frames as a target frame and projecting the high-density point cloud on a camera image plane of the target frame,
a process that forms a fourth depth image by using a camera image of the target frame according to the optical flow,
a process that compares the third depth image and the fourth depth image to detect an occlusion region, and
a process that extracts a depth of a region corresponding to the camera image of the target frame and not corresponding to the occlusion region, from among depths of the third depth image to obtain a high-density depth image of the target frame.

8. The information processing device according to claim 7, wherein, when a relative error of a depth included in the depths of the third depth image and located at an image position identical to an image position of a depth of the fourth depth image is larger than a threshold in the process that detects the occlusion region, the processing unit detects the image position of the corresponding depth of the third depth image as the occlusion region.

9. The information processing device according to claim 8, wherein the relative error is a value obtained by dividing an absolute value of a difference between a depth of the third depth image and a depth of the fourth depth image by the depth of the third depth image.

10. The information processing device according to claim 7, wherein, by using the high-density depth images corresponding to a plurality of the frames and obtained by the process that obtains the high-density depth image of the target frame, the processing unit further performs a process that generates datasets including sparse depth images obtained by projecting the high-density depth images, the camera images, and the LiDAR point clouds corresponding to the plurality of frames on the camera image plane, and stores the datasets in a database.

11. The information processing device according to claim 10, wherein the processing unit further performs a process that generates an inference model for obtaining the high-density depth images from the camera images and the sparse depth images on a basis of the datasets corresponding to the plurality of frames and stored in the database.

12. An information processing method comprising:
a procedure that forms a first depth image by projecting a LiDAR point cloud on a camera image plane;
a procedure that forms a second depth image by using a camera image according to an optical flow; and
a procedure that compares the first depth image and the second depth image to detect a moving body region or a non-moving body region.

13. An information processing device comprising:
a processing unit that performs
a process that generates a high-density point cloud by projecting LiDAR point clouds of a plurality of frames on an identical coordinate system and sequentially merging the LiDAR point clouds,
a process that forms a first depth image by designating at least any one of the plurality of frames as a target frame and projecting the high-density point cloud on a camera image plane of the target frame,
a process that forms a second depth image by using a camera image of the target frame according to an optical flow,
a process that compares the first depth image and the second depth image to detect regions of a moving body and an occlusion, and
a process that extracts a depth of a region corresponding to the camera image of the target frame and not corresponding to the regions of the moving body and the occlusion from depths of the first depth image to obtain a high-density depth image of the target frame.

14. The information processing device according to claim 13, wherein, when a relative error of a depth included in depths of the first depth image and located at an image position identical to an image position of a depth of the second depth image is larger than a threshold in the process that detects the regions of the moving body and the occlusion, the processing unit detects the image position of the corresponding depth of the first depth image as the regions of the moving body and the occlusion.

15. The information processing device according to claim 14, wherein the relative error is a value obtained by dividing an absolute value of a difference between a depth of the first depth image and a depth of the second depth image by the depth of the first depth image.

16. The information processing device according to claim 13, wherein, by using the high-density depth images corresponding to a plurality of the frames and obtained by the process that obtains the high-density depth image of the target frame, the processing unit further performs a process that generates datasets including sparse depth images obtained by projecting the high-density depth images, the camera images, and the LiDAR point clouds corresponding to the plurality of frames on the camera image plane, and stores the datasets in a database.

17. The information processing device according to claim 16, wherein the processing unit further performs a process that generates an inference model for obtaining the high-density depth images from the camera images and the sparse depth images on a basis of the datasets corresponding to the plurality of frames and stored in the database.

18. An information processing method comprising:
a procedure that generates a high-density point cloud by projecting LiDAR point clouds of a plurality of frames on an identical coordinate system and sequentially merging the LiDAR point clouds;
a procedure that forms a first depth image by designating at least any one of the plurality of frames as a target frame and projecting the high-density point cloud on a camera image plane of the target frame;
a procedure that forms a second depth image by using a camera image of the target frame according to an optical flow;
a procedure that compares the first depth image and the second depth image to detect regions of a moving body and an occlusion; and
a procedure that extracts a depth of a region corresponding to the camera image of the target frame and not corresponding to the regions of the moving body and the occlusion from depths of the first depth image to obtain a high-density depth image of the target frame.
